(19) United States
(12) Patent Application Publication
(10) Pub. No.: US 2024/0407361 A1
(43) Pub. Date: Dec. 12, 2024

(54) ORGANOSULFUR COMPOUNDS AS PLANT BIOSTIMULANTS

(71) Applicants: AHV International B.V., Zwolle (NL); Crop Health Vision B.V., Honselersdijk (NL)

(72) Inventors: Lex DE BOER, Waterlingen (NL); Ard Jan GRIMBERGEN, Berkel en Rodenrijs (NL)

(21) Appl. No.: 18/699,241

(22) PCT Filed: Oct. 7, 2022
(86) PCT No.: PCT/NL2022/050576

§ 371 Date: Apr. 5, 2024

(30) Foreign Application Priority Data
Oct. 8, 2021 (WO) PCT/NL2021/050610

(51) Int. Cl. A01N 41/08; A01G 7/06; A01N 25/04; A01N 37/46; A01N 41/12; A01P 21/00

(52) U.S. Cl. CPC A01N 41/08; A01G 7/06; A01N 25/04; A01N 37/46; A01N 41/12; A01P 21/00

(57) ABSTRACT

The disclosure relates to organosulfur containing compositions, in particular di-n-propyl thiosulfonate (PTSO) and di-n-propyl thiosulfinate (PTS), di-methyl thiosulfonate, di-phenyl thiosulfonate. Such compositions are useful for as biostimulants for plants. In particular such compositions may result in increased nutrient use efficiency, increased tolerance to abiotic stress, and/or improved quality characteristics. Compositions comprising said organosulfur compounds are also provided for agricultural use.

### FIELD OF THE INVENTION

The disclosure relates to organosulfur containing compositions, in particular di-n-propyl thiosulfonate (PTSO) and di-n-propyl thiosulfinate (PTS), di-methyl thiosulfonate, di-phenyl thiosulfonate and di-n-propyl disulfide. Such compositions are useful for as biostimulants for plants. In particular such compositions may result in increased nutrient use efficiency, increased tolerance to abiotic stress, and/or improved quality characteristics. Compositions comprising said organosulfur compounds are also provided for agricultural use.

### BACKGROUND OF THE INVENTION

Plants are cultivated, ideally, under optimal conditions in order to obtain desired characteristics such as high yield or high quality.

Growth conditions may be optimised in terms of root substrate, fertilisation, watering, drainage, light supply, temperature, air movement, air humidity and pest control. During crop and plant production in horticulture, most of mentioned growth conditions are kept under strict control. There are however situations where the control systems are not capable of keeping the optimal parameters under accurate control, for example sudden changes in weather conditions. Examples are alternating sunny and cloudy periods that result in short periods of light and high temperatures or vice versa; sudden temperature changes, such as cold nights that go together with increased heating and low humidity and result in high evaporation rates by the plants; long periods of cloudy weather that result in low photosynthesis rate and high humidity; long periods of sun that result in excess heat and low humidity and high evaporation by the plants.

Even during favourable growth periods, growth conditions may occur such that the plant is not able to take up sufficient water and nutrients and grows less rapidly compared to the situation that nutrients and water are present in excess.

Plant nutrients are chemical elements and compounds necessary for plant growth and/or plant metabolism. For example, for the growth and development of vascular plants, the following elements are needed, namely carbon (C), hydrogen (H), oxygen (O), nitrogen (N), phosphorus (P), potassium (K), sulfur (S), calcium (Ca), magnesium (Mg), boron (B), chlorine (Cl), copper (Cu), iron (Fe), manganese (Mn), molybdenum (Mo), nickel (Ni), and zinc (Zn). A number of vascular plants also need silicium (Si).

In agriculture, nitrogen (N), phosphorus (P), potassium (K), sulfur (S), calcium (Ca), magnesium (Mg), boron (B), chlorine (Cl), copper (Cu), iron (Fe), manganese (Mn), molybdenum (Mo), nickel (Ni), zinc (Zn) and silicium (Si) are generally provided in fertilisers. These elements can be supplied as relatively pure salts or as complex organic material, e.g. compost, plant waste, (partially) decomposed animal dung from cows, chickens, pigs etc. and are usually supplemented in excess, in order to prevent nutrient limitations.

It is clear that during agriculture in the open fields the plants are cultivated under conditions more variable than in greenhouses. Not only temperature, sunlight and root substrate/air humidity are important abiotic factors, but also wind, frost, salinity, flooding and drought. The described conditions result in abiotic stress for the crops and result in lower yields and/or worse quality parameters of the crops.

Abiotic stress is defined as the negative impact of non-living factors on the living organisms in a specific environment. It is clear that some crops and ornamental plants, even under controlled greenhouse conditions, have a lower tolerance to abiotic stress. This is strongly dependent on the species, subspecies hybrid, variant or cultivar.

In recent years, the use of plant biostimulants has emerged as a means to improve plant characteristics. According to Du Jardin, P (2012) “The science of plant biostimulants—a bibliographic analysis. Ad hoc Study Report to the European Commission DG ENTR; 2012”, a plant biostimulant is any substance or microorganism applied to plants with the aim to enhance nutrition efficiency, abiotic stress tolerance and/or crop quality traits, regardless of its nutrients content. Biostimulants have the capacity to modify physiological processes of plants in a way that provides potential benefits to growth, development and/or stress response.

One object of the present disclosure is to provide plant biostimulants suitable for use in agriculture.

### SUMMARY OF THE INVENTION

The disclosure provides the following preferred embodiments.

1. Use of a compound according to Formula I, or a composition comprising a compound according to Formula I, as a biostimulant for a plant; wherein Formula I is:

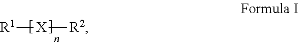

wherein n is 2;
wherein one X is —S— and the other X is selected from the group consisting of —S—, —S(O)—, and —S(O)₂—;
and R¹ and R² are independently selected from the group consisting of optionally substituted alkyl, optionally substituted aryl, optionally substituted heteroalkyl, optionally substituted heteroaryl, optionally substituted alkenyl, optionally substituted alkynyl, optionally substituted cycloalkyl, and optionally substituted heterocycloalkyl, preferably wherein the compound according to Formula I is di-n-propyl thiosulfonate (PTSO), di-n-propyl disulfide, di-methyl thiosulfonate, or di-phenyl thiosulfonate.

2. A method, comprising providing to a plant a compound according to Formula I, or a composition comprising a compound according to Formula I:

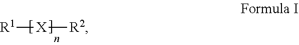

wherein n is 2;
wherein one X is —S— and the other X is selected from the group consisting of —S—, —S(O)—, and —S(O)₂—;
and R¹ and R² are independently selected from the group consisting of optionally substituted alkyl, optionally substituted aryl, optionally substituted heteroalkyl, optionally substituted heteroaryl, optionally substituted alkenyl, optionally substituted alkynyl, optionally substituted cycloalkyl, and optionally substituted heterocycloalkyl, preferably wherein the compound according to Formula I is di-n-propyl thiosulfonate (PTSO), di-n-propyl disulfide, di-methyl thiosulfonate, or di-phenyl thiosulfonate. Preferably the method is for increasing the growth rate, development, yield, and/or harvest of a plant. The method may also increase the vigor of a plant. Preferably the method is for increasing nutrient use efficiency, increasing tolerance of a plant to abiotic stress, improving the quality characteristics of a plant, and/or increasing the availability of nutrients retained in soil or in the rhizosphere for a plant

3. The use or method according to any one of the preceding embodiments, wherein R¹ and R² are independently selected from the group consisting of optionally substituted alkyl, and optionally substituted aryl.

4. The use or method according to any one of the preceding embodiments, wherein R¹ and R² are independently selected from C₁₋₆ alkyl, and phenyl; wherein the phenyl group is optionally substituted with C₁₋₃ alkyl or C₁₋₃ alkoxy; wherein preferably R¹ and R² are independently selected from methyl, ethyl, n-propyl, n-butyl, phenyl, p-tolyl, and 4-methoxyphenyl.

5. The use or method according to any one of the preceding embodiments, wherein R¹ and R² are identical.

6. The use or method according to any one of embodiments 1 to 4, wherein the compound according to Formula I is selected from the group consisting of di-n-propyl thiosulfonate (PTSO), S-methyl methanethiosulfonate, S-phenylbenzene thiosulphonate, di-n-propyl thiosulfinate (PTS), methyl methane thiosulfinate, butyl butane thiosulfinate, methyl propene thiosulfinate, di-n-propyldisulfide, dimethyl disulfide, diethyl disulfide, di-n-butyl disulfide, diphenyl disulfide, di-p-tolyl disulfide, and bis(4-methoxyphenyl) disulfide;
wherein preferably the compound according to Formula I is di-n-propyl thiosulfonate (PTSO) or di-n-propyl thiosulfinate (PTS).

7. The use or method according to any one of the preceding embodiments, wherein at least 60 wt %, preferably at least 80 wt %, more preferably at least 95 wt %, of organosulfur compounds in said composition are selected from compounds according to Formula I.

8. The use or method according to any one of the preceding embodiments, wherein when said composition comprises diallyl thiosulfinate, the ratio of the compound or compounds according to Formula I to diallyl thiosulfinate by weight is greater than 0.1 preferably greater than 1 and
wherein when said composition comprises diallyl disulfide, the ratio of the compound or compounds according to Formula I to diallyl disulfide by weight is greater than 0.1, preferably greater than 1.

9. The use according to any of the preceding embodiments wherein said use as a biostimulant improves one or more of the following:
a) nutrient use efficiency, b) tolerance to abiotic stress, c) quality characteristics, and d) availability of confined nutrients retained in soil or in the rhizosphere.

10. The use or method according to any one of the preceding embodiments, according to any of the preceding claims wherein the composition is essentially free of diallyl thiosulfinate.

11. The use or method according to any one of the preceding embodiments, according to any of the preceding claims wherein the composition is essentially free of diallyl disulfide.

12. The use, method or composition according to any of the preceding embodiments wherein the composition comprises at least 0.5 mg/L of a compound according to Formula I.

13. The use or method according to any of the preceding embodiments, wherein the plant belongs to the clade Embryophyta or to the clade Angiospermae.

14. The use or method according to any of the preceding embodiments, wherein the plant is selected from the group consisting of Phalaenopsis, Chrysanthenum, Solanum lycopersicum, and Lactuca sativa.

15. The use or method according to any of the preceding embodiments, wherein the composition further comprises a fertilizer, a pesticide, a wetting agent, an antimicrobial compound, disinfectant, chelating compound, aromatic compound, and/or an additional biostimulant.

16. The use or method according to any of the preceding embodiments, wherein said compound or composition is applied directly to said plant, to the seed of said plant, or to the soil of said plant or seed.

17. The use or method of embodiment 16, wherein said compound or composition is applied via drip irrigation.

18. A method comprising providing to a plant, preferably via irrigation, a composition comprising a compound according to Formula I:

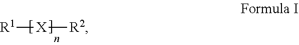

wherein n is 2;
wherein one X is —S— and the other X is selected from the group consisting of —S—, —S(O)—, and —S(O)₂—;
and R¹ and R² are independently selected from the group consisting of optionally substituted alkyl, optionally substituted aryl, optionally substituted heteroalkyl, optionally substituted heteroaryl, optionally substituted alkenyl, optionally substituted alkynyl, optionally substituted cycloalkyl, and optionally substituted heterocycloalkyl, preferably wherein the compound according to Formula I is di-n-propyl thiosulfonate (PTSO), di-n-propyl disulfide, di-methyl thiosulfonate, or di-phenyl thiosulfonate,
wherein said composition is provided to the plant at least six times during the crop cycle of the plant and/or the composition is provided to the plant every 4-21 days during the crop cycle of said plant.

19. The use, method, or composition according to any one of the preceding embodiments, wherein said composition comprises an emulsifier.

20. The use, method, or composition according to any one of the preceding embodiments, wherein said composition comprises an amino acid based biostimulant.

21. The use, method, or composition according to any one of the preceding embodiments, wherein said composition comprises free amino acids and peptides.

22. The use of method according to any one of embodiments 1-19, wherein said use or method further comprises providing to said plant an amino acid based biostimulant.

23. The use of method according to embodiment 22, wherein the amino acid based biostimulant comprises between 8-15% (w/w) free amino acids and between 45-55% attached amino acids.

24. The use of method according to any one of embodiments 22-23, wherein the composition comprising a compound according to Formula I and the amino acid based biostimulant are provided within the same crop cycle.

25. The use of method according to any one of embodiments 22-24, wherein the composition comprising a compound according to Formula I is provided at least 24 hours prior or 24 hours after the amino acid based biostimulant is provided to said plant.

### DETAILED DESCRIPTION OF THE DISCLOSED EMBODIMENTS

The disclosure provides organosulfur compounds for use as plant biostimulants as well methods to increasing the growth rate, development, yield, harvest of a plant, and other plant characteristics described herein.

In some embodiments, the organosulfur compound is a compound according to Formula I:

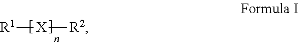

wherein n is 2;
wherein one X is —S— and the other X is selected from the group consisting of —S—, —S(O)—, and —S(O)₂—;
and R¹ and R² are independently selected from the group consisting of optionally substituted alkyl, optionally substituted aryl, optionally substituted heteroalkyl, optionally substituted heteroaryl, optionally substituted alkenyl, optionally substituted alkynyl, optionally substituted cycloalkyl, and optionally substituted heterocycloalkyl.

In preferred embodiments, the compound according to Formula I is not

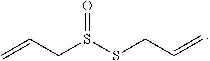

In preferred embodiments, the compound according to Formula I is not

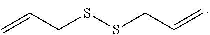

The compounds according to Formula I are referred to herein as “organosulfurorganosulfur compounds” or “the biostimulant organosulfurorganosulfur compounds”.

Preferably, R¹ and R² are independently selected from the group consisting of optionally substituted alkyl, and optionally substituted aryl. More preferably, R¹ and R² are independently selected from C₁₋₆ alkyl, and phenyl; wherein the phenyl group is optionally substituted with C₁₋₃ alkyl or C₁₋₃ alkoxy. Most preferably, R¹ and R² are independently selected from methyl, ethyl, n-propyl, n-butyl, phenyl, p-tolyl, and 4-methoxyphenyl.

In preferred embodiments, R¹ and R² are identical.

In preferred embodiments, each X is —S—. In preferred embodiments, one X is —S— and the other X is —S(O)—. In other preferred embodiments, one X is —S— and the other X is —S(O)₂—.

Preferably, the compound of Formula I is selected from the compound according to Formula I is selected from the group consisting of di-n-propyl thiosulfonate (PTSO), S-methyl methanethiosulfonate, S-phenylbenzene thiosulphonate, di-n-propyl thiosulfinate (PTS), methyl methane thiosulfinate, butyl butane thiosulfinate, methyl propene thiosulfinate, di-n-propyldisulfide, dimethyl disulfide, diethyl disulfide, di-n-butyl disulfide, diphenyl disulfide, di-p-tolyl disulfide, and bis(4-methoxyphenyl) disulfide. More preferably, the compound according to Formula I is di-n-propyl thiosulfonate (PTSO), or di-n-propyl thiosulfinate (PTS).

In preferred embodiments of formula I, n is 2 and one X is —S— and the other X is —S(O)₂—; and R¹ and R² are independently selected from C₁₋₆ alkyl and phenyl, preferably selected from the group consisting of methyl, phenyl, and n-propyl.

In preferred embodiments the compound of Formula I is propyl-propane thiosulfonate (PTSO), also referred to as di-n-propyl thiosulfonate. PTSO has the structure:

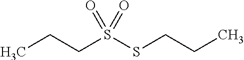

In preferred embodiments, the compound of Formula I is propyl-propane-thiosulfinate (PTS), also referred to as di-n-propyl thiosulfinate. PTS has the structure:

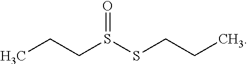

In preferred embodiments, the compound of Formula I is di-methyl thiosulfonate. In preferred embodiments, the compound of Formula I is di-phenyl thiosulfonate.

PTSO and PTS are preferred compounds of the disclosure and may be used together or individually as biostimulants and in the methods described herein.

As used herein, “alkyl” relates to a saturated aliphatic hydrocarbyl group. Unless stated otherwise, an alkyl group can be linear or branched. Preferably, alkyl groups are linear. As used herein, alkyl groups can be substituted or unsubstituted.

Preferably, alkyl groups are unsubstituted. In preferred embodiments, in Formula I an alkyl is a C₁₋₆ alkyl, more preferably a C₁₋₄ alkyl.

As used herein, “aryl” refers to an aromatic hydrocarbon ring system that comprises six to twenty-four carbon atoms, more preferably six to twelve carbon atoms, and may include monocyclic and polycyclic structures. When the aryl group is a polycyclic structure, it is preferably a bicyclic structure. Optionally, the aryl group is substituted by one or more substituents further specified in this document. Preferably, the aryl group is substituted with a methyl or methoxy group.

Examples of aryl groups are phenyl and naphthyl. Most preferably, an aryl group is phenyl.

As used herein, “alkenyl” relates to an unsaturated aliphatic hydrocarbyl group comprising one or more carbon-carbon double bonds. Unless stated otherwise, an alkenyl group can be linear or branched. Preferably, alkenyl groups are linear. As used herein, alkenyl groups can be substituted or unsubstituted. Preferably, alkenyl groups are unsubstituted. In preferred embodiments, in Formula I an alkenyl is a C₂₋₆ alkenyl, more preferably a C₂₋₄ alkenyl.

As used herein, “alkynyl” relates to an unsaturated aliphatic hydrocarbyl group comprising one or more carbon-carbon triple bonds. Unless stated otherwise, an alkynyl group can be linear or branched. Preferably, alkynyl groups are linear. As used herein, alkynyl groups can be substituted or unsubstituted. Preferably, alkynyl groups are unsubstituted. In preferred embodiments, in Formula I an alkynyl is a C₂₋₆ alkynyl, more preferably a C₂₋₄ alkynyl.

As used herein, “cycloalkyl” refers to a cyclic saturated aliphatic hydrocarbyl group. Cycloalkyl groups can be substituted or unsubstituted. Preferably, cycloalkyl groups are unsubstituted. In preferred embodiments, in Formula I a cycloalkyl is a C₃₋₆ cycloalkyl, more preferably a C₃₋₅ cycloalkyl.

As used herein, “heteroalkyl” relates to a saturated aliphatic hydrocarbyl group containing one or more heteroatoms. Unless stated otherwise, a heteroalkyl group can be linear or branched. Preferably, heteroalkyl groups are linear. As used herein, heteroalkyl groups can be substituted or unsubstituted. Preferably, heteroalkyl groups are unsubstituted. In preferred embodiments, in Formula I an heteroalkyl is a C₁₋₆ heteroalkyl, more preferably a C₁₋₄ heteroalkyl. Preferably, heteroalkyl groups contain one or more heteroatoms selected from the group consisting of O, N, and S, More preferably, heteroalkyl groups contain at most two heteroatoms, most preferably one heteroatom. Examples of suitable heteroalkyl groups include alkoxy groups (such as methoxy and ethoxy groups), and ethers.

As used herein, “heterocycloalkyl” refers to a cyclic saturated aliphatic hydrocarbyl group containing one or more heteroatoms. Heterocycloalkyl groups can be substituted or unsubstituted. Preferably, heterocycloalkyl groups are unsubstituted. In preferred embodiments, in Formula I a heterocycloalkyl is a C₁₋₅ heterocycloalkyl, more preferably a C₂₋₄ heterocycloalkyl. Preferably, a heterocycloalkyl group is a 5-membered or 6-membered ring structure containing at most two heteroatoms, more preferably one heteroatom. Preferably, heterocycloalkyl groups contain heteroatoms selected from the group consisting of O, N, and S.

As used herein, “heteroaryl” refers to an aromatic ring system comprising one or more heteroatoms. Preferably, heteroaryl groups comprise at least two carbon atoms (i.e. at least C₂) and one or more heteroatoms N, O, or S. Preferably, heteroaryl groups contain at most five carbon atoms. Preferably, heteroaryl groups contain at most two heteroatoms selected from the group consisting of N, O, and S.

In preferred embodiments, heteroaryl groups are 5-membered or 6-membered ring structures. Optionally, the heteroaryl group may be substituted by one or more substituents further specified in this document. Preferably, the heteroaryl groups are unsubstituted. Examples of suitable heteroaryl groups include pyridinyl, quinolinyl, pyrimidinyl, pyrazinyl, pyrazolyl, imidazolyl, thiazolyl, pyrrolyl, furanyl, triazolyl, benzofuranyl, indolyl, purinyl, benzoxazolyl, thienyl, phospholyl and oxazolyl.

As used herein, “substituted” indicates that a group contains one or more substituents. Preferably, the substituents are independently selected from the group consisting of halogen, C₁₋₃ alkyl, —C(O)OH, —C(O)NH₂, —OH, =O, C₁₋₃ alkoxy, —NH₂, —NH—C₁₋₃ alkyl, —NHC(O)—C₁₋₃ alkyl, —NO₂, —SO₃H, and CF₃. Preferably, halogens are selected from the group consisting of —Cl, —F, —Br, and —I. In preferred embodiments, the groups as disclosed herein contain at most three substituents, more preferably at most two substituents, and most preferably at most one substituent.

A number of organosulfurorganosulfur compounds have been identified in extracts from plants belonging to the Allium family. Propyl-propane-thiosufinate (PTS) is a natural compound found in plants belonging to the Allium family; in particular Allium cepa (onion), Allium ampeloprasum (leek), Allium schoenoprasum (chive) and Allium chinense (Chinese onion). Propiin is hydrolysed by alliinase into propylsulfenic acid which condenses to produce PTS under loss of water (J. Chromatogr. A 1112 (2006) 3-22). Further reactions with PTS result in the production of PTSO. One of the best plant sources for PTS is from Allium schoenoprasum (chive) (see, table 3 of Rose et al. Nat. Prod. Rep., 2005, 22, 351-368). In contrast to PTS, PTSO is not present in onions. Although PTSO has been described in the literature as “Allium derived”, the inventors are not aware of any literature describing the measurement of PTSO from onion extract. Example 10 demonstrates that PTSO is not present at detectable limits in onion oil, onion extract, garlic oil, or garlic extract.

Allium sativum (garlic) is reported to have non-detectable levels of PTS but significant amounts of allicin (i.e., diallyl thiosulfinate), which is not detectable in extracts of Allium cepa (onion), Allium ascalonicum (shallot), or Allium schoenoprasum (chive) (Rose et al.) Allicin is produced, upon raw garlic tissue damage from the non-proteinogenic amino acid alliin (S-allylcysteine sulfoxide) in a reaction that is catalyzed by the enzyme alliinase, as a major compound along with a small amount of methyl allyl thiosulfinate (Molecule, 19, 2014, 12591-12618 and J. Chromatogr. A 1112 (2006) 3-22). Allicin is unstable and quickly converts into a series of other sulfur-containing compounds such as diallyl disulfide. Since allicin is an unstable compound, its use in agriculture is limited (Fujisawa et al (2008) J Agric Food Chem: 56 (11): 4229-4235.

The compounds can be either extracted from a natural source or can be produced synthetically. Both compounds PTS and PTSO are also commercially available. In some embodiments, the compounds are obtained from natural sources such as plants. Compounds can be extracted from plant material in various ways. The appropriate method depends on the chemical properties of the compounds. For example, the extraction can start with a non-polar solvent and follow that with solvents of increasing polarity. Alternatively, the compounds of the plant can be extracted in alcohol.

The disclosure provides compositions comprising the biostimulant organosulfurorganosulfur compounds disclosed herein (i.e. according to Formula I). In some embodiments, the composition comprises at least 40%, preferably at least 50%, of one or more organosulfurorganosulfur compounds. Preferably, the composition comprises at least 40%, preferably at least 50%, of PTSO. In some embodiments, the composition further comprises PTS, preferably less than 20%, more preferably less than 10% PTS. Such compositions are also referred to herein as a “concentrated solution of organosulfurorganosulfur compound”.

In some embodiments, at least 60 wt %, preferably at least 80 wt %, more preferably at least 95 wt %, of organosulfurorganosulfur compounds of the composition as disclosed herein are selected from compounds according to Formula I. In some embodiments, at least 60 wt %, preferably at least 80 wt %, more preferably at least 95 wt %, of organosulfurorganosulfur compounds of the composition as disclosed herein are selected from PTSO and PTS.

The concentrated compositions will generally be diluted from between 1:100 to 1:100,000 before use to form working solutions. Herein, it will be understood that “working” indicates that the composition, e.g. a solution, can be applied to a plant, and not that other concentrations would relate to non-working embodiments.

Suitable compositions comprise at least 0.5 mg/L of a organosulfurorganosulfur compound disclosed herein. Preferably, the composition comprises at least 0.5 mg/L, more preferably at least 1 mg/L of organosulfur compound (in particular PTSO) In some embodiments, a working solution comprises at least 10 mg/L of organosulfur compound (in particular at least 10 mg/L of PTSO).

Preferably, the composition comprises at least 1 μmol/L, more preferably at least 10 μmol/L of organosulfur compound (in particular PTSO). In some embodiments, a working solution comprises at least 35 μmol/L of organosulfur compound (in particular at least 35 μmol/L of PTSO, more particularly at least 50 μmol/L of PTSO).

Preferably, the composition, in particular when used as a working solution, comprises at most 10 mmol/L, more preferably at most 8 mmol/L of organosulfur compound (in particular PTSO). In some embodiments, a working solution comprises at most 6 mmol/L of organosulfur compound (in particular PTSO). In preferred embodiments a working solution comprises at most 3.5 mmol/L of PTSO, more preferably at most 1.5 mmol/L.

In preferred embodiments, the compound according to Formula I is applied to plants (i.e., working solution) at a concentration of at most 200 mg/L, preferably at most 150 mg/L, more preferably at most 100 mg/L. In preferred embodiments, the composition that is applied to plants comprises at most 50 mg/L In some embodiments, the composition applied to plants comprises between 0.5-150 mg/L, preferably between 0.5-100 mg/L. In some embodiments, the composition applied to plants comprises between 0.5-50 mg/L. In some embodiments, the composition applied to plants comprises between 1-50 mg/L. In some embodiments, the composition applied to plants comprises between 1-10 mg/L.

As a skilled person will recognize, the amount of PTSO needed will depend on the size of the crop, as larger crops generally need higher amounts. As an exemplary embodiment, an average plant density may be, e.g. 30,000 plants/ha and 10,000 liters PTSO solution/ha is applied.

In some embodiments, the compositions comprise additional organosulfur compounds, which may or may not also act as biostimulants. Preferably, at least 60 wt % of organosulfur compounds in said composition are selected from compounds according to Formula I.

In some embodiments, when said composition comprises diallyl thiosulfinate, the ratio of the compound or compounds according to Formula I to diallyl thiosulfinate by weight is greater than 0.1 preferably greater than 1, and more preferably at least 10:1. It will be understood that when the composition comprises more than one compound of Formula I, the weight of all these compounds is compared to the weight of diallyl thiosulfinate to arrive at said ratio.

In some embodiments, when said composition comprises diallyl disulfide, the ratio of the compound or compounds according to Formula I to diallyl disulfide by weight is greater than 0.1, preferably greater than 1, and more preferably at least 10:1. It will be understood that when the composition comprises more than one compound of Formula I, the weight of all these compounds is compared to the weight of diallyl disulfide to arrive at said ratio.

Preferably, such compositions are substantially free of diallyl thiosulfinate. As used herein, “substantially free”, when referring to concentrated compositions having, for example, 50% or more of PTSO, refers to compositions comprising less than 5 wt %, preferably less than 1 wt %, more preferably less than 0.5 wt % diallyl thiosulfinate. Working solutions that have been diluted will comprise significantly less diallyl thiosulfinate.

The compositions of the present disclosure are also preferably substantially free of diallyl disulfide. As used herein, “substantially free”, when referring to concentrated compositions having, for example, 50% or more of PTSO, refers to compositions comprising less than 5 wt %, preferably less than 1 wt %, more preferably less than 0.5 wt % diallyl disulfide. Working solutions that have been diluted will comprise significantly less diallyl disulfide.

The compositions may include any suitable “agriculturally acceptable carrier, excipient, and/or solvent”. Such carriers and solvents are known to a skilled person. and are not unacceptably damaging to a plant or its environment, and/or not unsafe to the user or others that may be exposed. For example, an agriculturally acceptable carrier may be a solid carrier, a gel carrier, a liquid carrier, a suspension, or an emulsion. A non-limiting example of a solvent is water.

In preferred embodiments, the compositions further comprise an emulsifier. Suitable emulsifiers include propylene glycol and glyceryl polyethyleneglycol ricinoleate. Yuka extract as well as Tween are also suitable emulsifiers. In some embodiments, the compositions comprise 40-70% of an emulsifier, preferably between 55-60% emulsifier, in particular when the emulsifier is a combination of propylene glycol and glyceryl polyethyleneglycol ricinoleate. In some embodiments, the compositions comprise 70-92% of an emulsifier, preferably around 90% emulsifier, in particular when the emulsifier is yuka extract. In some embodiments, the compositions comprise 25-70% of an emulsifier, preferably between 25-35% emulsifier, in particular when the emulsifier is tween. Preferably, the composition comprises between 1-30%, preferably 3-10%, of a compound as disclosed herein (e.g., PTSO). The composition may further comprise vitamins and minerals such as vitamin H, vitamin B1, B2, B3, B5, B6, and B12. Such compositions can be diluted to a working solution to be applied on the plant as disclosed further herein.

In some embodiments, the composition further comprises a fertilizer, a pesticide, a wetting agent, an antimicrobial compound, disinfectant, chelating compound, aromatic compound, and/or an additional biostimulant.

A skilled person will also appreciate that a fertilizer, a pesticide, a wetting agent, an antimicrobial compound, disinfectant, chelating compound, aromatic compound, and/or an additional biostimulant (in particular an amino acid based biostimulant as described herein) may also be provided in a separate composition. For example, the disclosure further contemplates methods comprising providing to said plant a compound or composition of the invention as disclosed herein and providing to the plant one or more additional agents selected from fertilizer, a pesticide, a wetting agent, an antimicrobial compound, disinfectant, chelating compound, aromatic compound, and/or an additional biostimulant. Preferably, the additional agent is provided at around the same time as a compound of the invention. The additional agent may also be provided before or after a compound of the invention, for example several hours or days before or after a compound of the invention. Preferably the compound of the invention and the additional agent are provided within 7 days of each other. The additional agent is preferably provided multiple times during a crop cycle. For example, the additional agent may be applied every 4-14 days. The additional agent may be applied at least 4, preferably at least 6 times during a crop cycle. In particular, the composition comprising formula I and the additional agent are both provided during the same crop cycle.

In some embodiments, the methods and uses disclosed herein further comprise applying an amino acid based biostimulant to a plant. An “amino acid based biostimulant” as referred to herein comprises at least 10%, preferably at least 15% (w/w) amino acids. In some embodiments, the biostimulant comprises at least 50%, preferably at least 55% (w/w) amino acids. The amino acids may be free amino acids (i.e., free form amino acids) or attached to other amino acids (e.g., via peptide bonds). In some embodiments, the amino acid biostimulant comprises between 8-15% (w/w) free amino acids and between 45-55% attached amino acids. Such biostimulants are generally diluted 1:10 to 1:1,000 prior to use.

Amino acid based biostimulants and their method of use are known to a skilled person and include Metalosate Calcium and Metalosate Fe (Albion Minerals, Layton, UT, USA); Agrocean B (Agrimer, Plouguerneau, France); Tecamin Brix, Tecamin Max, Tecnokel Amino Mix, and Terra-Sorb Foliar (Agritecno Fertilizantes, Valencia, Spain); Amino Quelant Ca (Bioibérica, Barcelona, Spain); Bosfoliar Activ (COMPO EXPERT, Münster, Germany); NaturalCrop SL (NaturalCrop Poland Sp. z o.o., Warszaw, Poland); and Delfan Plus (Tradecorp, Madrid, Spain). See table 2 of Molecules. 2018 February; 23(2): 470 for a description of the composition of amino acid biostimulants AminoPrim and AminoHort, containing 15% and 20% amino acids, respectively, and 0.27% and 2.1% microelements, respectively.

Terra Sorb™ Complex is another suitable amino acid based biostimulant comprising 20% (w/w) free amino acids; ASP, SER, GLU, GLY, HIS, ARG, THR, ALA, PRO, CIS, TYR, VAL, MET, LYS, ILE, LEU, PHE, and TRP. Terra Sorb Complex also contains 5.5% nitrogen of which 5% is organic N, as well as B (1.5%), Mg (0.8%), Fe (1%), Zn (0.1%), Mn (0.1%), Mo (0.001%), and 25% organic matter.

A preferred amino acid based biostimulant is Isabion™. Isabion™ is a mixture of water, ashes, free amino acids, as well as short-chain and long-chain peptides.

Preferably, Isabion is a mixture of 33.5% (w/w) of water, 4% (w/w) of ashes and 62.50% (w/w) of organic matter. In particular, the mixture comprises 10.3% (w/w) free amino acids and 47.96% (w/w) attached amino acids. Free amino acids include 3.80% (w/w) of glycine, 1.45% (w/w) of proline, 1.87% (w/w) of alanine, 0.27% (w/w) of glutamic acid, 0.85% (w/w) of hydroxy-proline, 0.35% (w/w) of aspartic acid, 0.20% (w/w) of leucine, 0.35% (w/w) of lysine, 0.09% (w/w) of valine, 0.33% (w/w) of tyrosine, 0.16% (w/w) of phenylalanine, 0.07% (w/w) of isoleucine, 0.12% (w/w) of arginine, 0.08% (w/w) of threonine, 0.08% (w/w) of methionine, 0.10% (w/w) of histidine and 0.13% (w/w) of serine.

Attached amino acids include 8.65% (w/w) of glycine, 8.78% (w/w) of proline, 5.16% (w/w) of alanine, 6.33% (w/w) of glutamic acid, 5.35% (w/w) of hydroxy-proline, 2.71% (w/w) of aspartic acid, 1.90% (w/w) of leucine, 1.68% (w/w) of lysine, 1.67% (w/w) of valine, 1.14% (w/w) of tyrosine, 1.18% (w/w) of phenylalanine, 0.87% (w/w) of isoleucine, 0.80% (w/w) of arginine, 0.66% (w/w) of threonine, 0.57% (w/w) of methionine, 0.37% (w/w) of histidine and 0.14% (w/w) of serine.

Further, attached amino acids can be short chain peptides and/or long chain peptides. The molecular weight of the short chain peptides is generally between approximately 1160 Da to approximately 3500 Da. The molecular weight of the long chain peptides is generally between approximately 3600 Da to approximately 8500 Da.

Isabion is usually diluted with water and applied in a manner of foliar spraying or in irrigation water. When providing a working solution for foliar spraying, Isabion is normally diluted as 200-300 ml/100 L water.

The recommended dosage of Isabion is between 200 ml/hl to 300 ml/hl for foliar spraying and 2 l/ha to 3 l/ha for irrigation system. In case of frost or affected crops the dosage can be increased up to 400 ml/hl for foliar spraying and up to 4 l/ha for irrigation system.

| | Foliar spraying | irrigation system | |
|---|---|---|---|
| Citrus, cereals, forage | 200-300 cc/100 L of water | 2-3 | l/ha |
| crops, fruit crops, | After frost and for | 4 | L/ha |
| horticultural crops, | affected crops: 400 | | |
| industrial crops, olive | ml/100 L water | | |
| tree, ornamental, | | | |
| grapevine, betroot | | | |

In an exemplary embodiment, a method is provided comprising providing to said plant a compound according to Formula I, or a composition comprising a compound according to Formula I and providing to said plant an amino acid based biostimulant such as Isabion™.

In some embodiments, the compound according to Formula I and the amino acid based biostimulant are provided in a single composition. Accordingly, the disclosure provides compositions comprising a compound according to Formula I and an amino acid based biostimulant.

In some embodiments, a composition comprises a compound according to Formula I, glycine, and proline. In some embodiments, a composition comprises a compound according to Formula I and free amino acids selected from the group comprising glycine and proline. Preferably, comprises a compound according to Formula I, free amino acids selected from the group comprising glycine and proline, and peptides.

Preferably, the composition further comprises free amino acids selected from the group comprising alanine, glutamic acid, and hydroxy-proline; more preferably, the composition even further comprises free amino acids selected from the group comprising aspartic acid, leucine, lysine, valine, tyrosine, phenyl-alanine, isoleucine, arginine, threonine, methionine, histidine, and serine.

In some embodiments a composition is provided, comprises a compound according to Formula I; alanine, glutamic acid, hydroxy-proline, aspartic acid, leucine, lysine, valine, tyrosine, phenyl-alanine, isoleucine, arginine, threonine, methionine, histidine, serine, glycine and proline as free amino acids; and peptides.

In a preferred embodiment, the composition comprising Formula I as described herein and the amino acid based biostimulant as described herein are provided as separate compositions. Preferably, the composition comprising a compound according to Formula I is provided at least 24 hours prior (or between 1-3 days prior) or 24 hours after (or between 1-3 days after) the amino acid based biostimulant is provided to said plant. A kit of parts is also provided comprising i) a composition comprising Formula I as described herein and ii) an amino acid based biostimulant as described herein.

In preferred embodiments, the composition comprising Formula I further comprises cadmium (Cd) in an amount of at most 1.5 mg/kg dry matter. In preferred embodiments, the composition comprises hexavalent chromium (Cr VI) in an amount of at most 2 mg/kg dry matter. In preferred embodiments, the composition comprises lead (Pb) in an amount of at most 120 mg/kg dry matter. In preferred embodiments, the composition comprises mercury (Hg) in an amount of at most 1 mg/kg dry matter. In preferred embodiments, the composition comprises nickel (Ni) in an amount of at most 50 mg/kg dry matter. In preferred embodiments, the composition comprises inorganic arsenic (As) in an amount of at most 40 mg/kg dry matter. In preferred embodiments, the composition comprises inorganic zinc (Zn) in an amount of at most 1500 mg/kg dry matter.

di-methyl Thiosulfonate, di-phenyl Thiosulfonate

The disclosure provides the organosulfur compounds and compositions comprising said compounds as disclosed herein, for use as plant biostimulants. Said compounds and compositions may be used in methods for treating plants. Such methods may be useful for increasing the growth rate and/or development of plants, increasing the yield of plants, or increasing the harvest of plants.

In some embodiments, methods are provided comprising providing a plant with the compounds or compositions disclosed herein. A plant may be provided with said compounds or compositions by any means known in the art such as topical, watering feed, spray or damp solution, coating, piling, aerial solution, epidermal, intravascular via the roots, flowers, leaves and stalks. Preferred routes are uptake via the roots, spraying, aerial or topical administration. A preferred route of administration is via the roots using irrigation (e.g., drip/trickle irrigation). While not wishing to be bound by theory, providing the compounds directly to the roots may provide an improved effect over, e.g., spraying the leaves. Compare results between spray and drip irrigation in Table 17. Spraying the plants can also be effective, in particular when the composition is able to soak into the ground and reach the roots.

In some embodiments, a compound of the invention is provided multiple times during a crop cycle. As used herein, a crop cycle refers to the time from germination until crop harvest.

For example, the compound may be applied at least 4, preferably at least 6 times during a crop cycle. Preferably, the compound is applied every 4-27 days, in particular every 4-14 days. In an exemplary embodiment, the compound is provided every 1-2 weeks. In an exemplary embodiment the compound is provided every 4-27 days, preferably every 4-14, days and at least 4, preferably at least 6, times during a crop cycle. The first administration of said compound is preferably shortly after germination. Although the effect of the compounds lasts for several weeks after the last administration, it is recommended to apply the compound at least until 7 days prior to expected harvest.

Said compounds or compositions may be applied to a plant (including cuttings, emerging seedlings, and established vegetation, including roots and above-ground portions, for example, leaves, stalks, flowers, fruits, branches, limbs, root, arId the like), to the seed of a plant (e.g., prior to germination), or to the surrounding soil, in particular the plant rhizosphere. As used herein, the term rhizosphere refers to area of soil adjacent to the roots of living plants. The width of the rhizosphere is generally within 100 mm from the root surface.

The compounds and compositions may be applied in a single administration or as multiple administrations. For example, the compositions may be provided daily, weekly, monthly or annually. In an exemplary embodiment the composition may be provided once daily for a week or until the biostimulant becomes effective.

Watering the plants are performed as watering turns and the amount of supplied water is chosen such, that the plants discharge a part of the supplied water as drain. This means that organosulfur compositions rinse out relatively fast. To enable an even concentration in the root substrate, the organosulfur compositions may be dosed as a granulate that releases the composition at the desired rate. In this manner constant concentrations are provided over longer periods.

In some embodiments, the compositions disclosed herein are provided as a spray solution. When the compositions are sprayed on the plants, the solution may be deposited on the leaves as droplets with a small surface volume ratio that evaporate, which may lead to the compositions remaining of the leaves as a residue. This effect can be reduced by including a wetting agent to the compositions.

The amount of organosulfur compounds applied will depend upon a variety of factors including, the method of administration, the time of administration, the rate of decomposition of the particular compound being employed, the duration of the treatment, pesticide treatment, compounds and/or materials used in combination, the age, weight, general health and prior treatments, and like factors well known in the agricultural arts. A horticulturist, plant grower or a farmer having ordinary skill in the art can readily determine the effective amount of the composition required.

It is clear to a skilled person that lower concentrations/amounts of the organosulfur compounds can be administered to slow growing plants, e.g. cactus and succulents. It is also clear to a skilled person that the concentrations/amounts in water and frequency of application are dependent on the plant species, subspecies, cultivar, hybrid, variant. Furthermore, it is clear to a skilled person in the art that the dosage that the plants can tolerate, is dependent on the growth stage and size of the plant. Furthermore, it is clear to a skilled person in the art that the concentrations/amounts in water and frequency of application are dependent on the growth conditions e.g. light, temperature, evaporation, nutrient concentration and pH in the root substrate, air movement and the application of other pesticides. Furthermore, it is clear to a skilled person in the art that the concentrations/amounts in water and frequency of application is dependent on the moment that it is administered, day, night and the season and weather conditions.

In an exemplary embodiment, the organosulfur compound, preferably PTSO, is provided in an amount of from 0.01 kg/ha to 100 kg/ha.

Preferably, for use on orchids, preferably Phalaenopsis, the organosulfur compound, preferably PTSO, is provided in an amount of from 10 kg/ha to 100 kg/ha, more preferably from 20 kg/ha to 60 kg/ha. Preferably, for use on Chrysanthemum the organosulfur compound, preferably PTSO, is provided in an amount of from 0.01 kg/ha to 1 kg/ha, more preferably from 0.01 kg/ha to 0.25 kg/ha.

In some embodiments, the compound of Formula I, or a composition comprising said compound, is applied directly to said plant, to the seed of said plant, or to the soil of said plant or seed.

As demonstrated in the examples, the compounds disclosed herein have advantageous effects on plants, in particular on the quality characteristics of plants. Said compounds are therefore useful as plant/soil additives, fertilizers, and biostimulants.

In a preferred embodiment, the term “biostimulant” as used herein refers to a product, in particular a compound or composition, that stimulates the nutritional processes of a plant independently of the nutrient content of the product with the aim of improving one or more of the following properties of the plant or the plant rhizosphere: a) nutrient use efficiency, b) tolerance to abiotic stress, c) quality traits (also known as quality characteristics), and d) availability of confined nutrients in soil or rhizosphere.

In a preferred embodiment, the use of a compound as described herein as a biostimulant, relates to improving one or more of the following:
a) nutrient use efficiency, b) tolerance to abiotic stress, c) quality traits, and d) availability of confined nutrients retained in soil or in the rhizosphere.

In preferred embodiments, the use as a biostimulant does not encompass the use as an antimicrobial and/or antifungal agent.

Preferably, the organosulfur compounds disclosed herein:
increase nutrient use efficiency and/or
increase tolerance of a plant to abiotic stress and/or
improve the quality characteristics of a plant and/or
increase the availability of nutrients retained in soil or in the rhizosphere for a plant.

More preferably, the organosulfur compounds disclosed herein:
increase nutrient use efficiency and/or
increase tolerance of a plant to abiotic stress and/or
improve the quality characteristics of a plant.

### Nutrient Use Efficiency

As used herein, nutrient use efficiency is used in its normal definition in the art. Typically, nutrient use efficiency is defined as yield (biomass) per unit input (fertilizer, nutrient content) (see, e.g., Nutrient Use Efficiency in Plants, Concepts and Approaches, Editors: Hawkesford, Malcolm J., Kopriva, Stanislav, De Kok, Luit J. (Eds.) ISBN 978-3-319-10635-9). Preferably, the nutrient is nitrogen (N) and/or phosphorus (P).

The skilled person is well aware of methods to determine the nutrient use efficiency of a plant, and therefore is also fully capable of establishing whether a biostimulant increases said nutrient use efficiency. For example, in field studies nutrient use efficiencies can be either calculated based on differences in crop yield and/or nutrient uptake between plots treated with a biostimulant and an untreated control, or by using isotope-labeled nutrients to estimate crop and soil recovery of applied nutrients (see for example A. Dobermann, Nutrient use efficiency—measurement and management, in: Fertilizer Best Management Practices, 2007, ISBN: 2-9523139-2-X).

### Abiotic Stress

As used herein, abiotic stress is defined as the negative impact of non-living factors on living organisms in a specific environment. As such, an improvement of tolerance of a plant to abiotic stress indicates that the plant is better capable to tolerate abiotic stress factors that typically have a negative impact on the plant, e.g. reduction of plant growth rate. Abiotic stress factors include, but are not limited to, drought, excess of water (in particular, too much rain or too high a humidity), too much or too little direct sunlight, strong wind, suboptimal soil structure, salinity (in particular hypersalinity), too low or too high temperatures, strong and/or sudden fluctuations in temperature, and other environmental extremes. By contrast, plant pathogens or insect pests are referred to as biotic stresses.

The negative impact on the plant resulting from abiotic stress includes, but is not limited to, slower growth rate of the plant, lower maximum height of the plant, decreased root formation, improper leaf development (such as smaller leaves, leaves having a different colour), higher susceptibility to insect damage or pathogen damage, and fewer flowers or flower stalks.

An average improvement of the tolerance to abiotic stress of a plant as the result of treating a plant with a biostimulant can be measured by comparing plots with plants treated with a biostimulant with an untreated control, wherein the treated plants and control plants are subjected to substantially the same abiotic stress factors, e.g. when the treated plants and control plants are grown on the same or neighboring plots.

In a preferred embodiment the abiotic stress is drought, excess of water, direct sunlight, heat, and/or coldness, that results in slower growth, decreased root formation, pale or red leaves, higher susceptibility to insect or pathogen damage, and/or fewer flowers or flower stalks, in a plant of the genus Phalaenopsis.

In a preferred embodiment, the abiotic stress relates to the uptake of too little nutrients or too little water because of the lack of sufficient roots, too high temperatures, and/or air movement that results into poor and slow root formation in a plant of the genus Chrysanthemum.

### Quality Traits

The definition of quality traits (also known as quality characteristics) may depend on the plant genus or species. Typically, the skilled person, e.g. a farmer or a grower, knows which plant relates to which quality trait.

Some examples of crops/ornamental plants and some of their quality characteristics are described below. Other quality traits are described at table 31.

| Crop | Quality characteristic |
|---|---|
| Potato | Firmness |
| | Shape |
| | Regular and colour peel |
| | No sprouted tuber |
| Onions | Firmness |
| | Shape |
| | Colour |
| | Not sprouted bulb |
| lettuce | Leaf colour |
| | No deviating leaf margins |
| | FirmnessNot too compact |
| chicory | White/pale green |
| | No brown spots |
| | No deviating leaf margins |
| Ornamental plants | |
| Chrysanthemum | Correct number of flowers, flower size |
| | Correct ratio flowers/buds |
| | Correct length stalks |
| | All stalks have the same length |
| | No spots on leaves and flowers |
| Phalaenopsis | Many flowers |
| | Number of flower stalks |
| | Plant firmness |
| | Shape of leaves |
| | Colour leaves |
| | No spots on leaves |
| | Shine on the leaves |
| Ferns | Colour leaves |
| | no yellow/brown parts on leaves |
| | Plant firmness |
| | Presence of external roots |

The term “improvement in plant quality” refers to the qualitative or quantitative improvement of certain traits when compared with the same trait in a control plant which has been grown under the same conditions in the absence of the application of the compounds disclosed herein. Such traits include, but are not limited to, improved visual appearance of the plant, improved quality of harvested material, e.g. seeds, fruits, leaves, vegetables; including visual improvement of harvested material, improved nutritional content, enhanced shelf-life, etc.

In some embodiments, the plant quality is plant vigor. Improved plant vigor includes, e.g., improved plant vitality of the plant; improved plant stand; improved emergence; and/or more developed root system; enhanced nodulation; larger leaf blade; improved leaf color, increased plant size; increased plant weight; increased plant height; increased yield when grown on poor soils or unfavorable climate; earlier flowering/fruiting/germination/grain maturity; faster and more uniform ripening; and the like.

In some embodiments, the plant quality is plant yield and refers to the yield of a plant (e.g., grains, nuts, fruits, vegetables, seeds, etc). Improved plant yield includes, e.g., an increase in biomass production and an improved ability to harvest plant matter.

In some embodiments, improved quality characteristics refers to one or more of the following characteristics selected from improved visual appearance of the plant, improved quality of harvested material, improved nutritional content, enhanced shelf-life, improved plant vigor, and improved plant yield.

### Availability of Confined Nutrients Retained in Soil or in the Rhizosphere

As the skilled person is aware, part of the nutrients may be confined in the soil or in the rhizosphere, rendering some amount of nutrients unavailable to the plant. Confined nutrients include, but are not limited to, nutrients with low mobility in the soil or rhizosphere, and/or nutrients that are poorly soluble in water. Low mobility may for example be the result of the nutrient interacting with other soil components, such as clay-sized particles or mineral-associated organic matter. The physicochemical interactions between the nutrient and the other soil component may result in limited availability of the nutrient to the plant (Jilling et al. Biogeochemistry (2018) 139: p. 103-122).

Various methods to measure the availability of confined nutrients in soil and the rhizosphere are available (see, for example, Brinkley and Vitousek, Soil nutrient availability, in: Plant Physiological Ecology: Field Methods and Instrumentation (ed. by Pearcy, Ehleringer, Mooney, and Rundel), 2000, ISBN: 13:978-0-412-40730-7).

Furthermore, methods are provided for:
increasing the growth rate and/or development of plants,
increasing the yield of plants,
increasing the harvest of plants. As is understood by the skilled person, an increase in, e.g., in the growth rate of a plant refers to the increase of growth rate of a planted treated with a compound disclosed herein as compared to the growth rate of a plant grown under similar conditions without treatment.

As used herein, the term “plant” encompasses crop plants, ornamentals, trees, grasses, annuals, perennials or any other commonly cultivated member of the kingdom Plantae. The term “crop plant” as used herein includes plant species with commercial value, which are planted and cultivated for commercial use. Thus, crop plants include floral and non-floral plants, perennials and annuals, trees, shrubs, vegetable plants, fruit trees, turf, and ground cover.

Suitable plants include Cymbidium, Oncidium, Miltonia, Paphiopedilum, Cypripedium, Calanthe and the orchid genus hybrids, Bromelia, Begonia, Impatiens, Azalea, ferns; the horticultural crops sweet pepper, tomato, egg-plant, cucumber, zucchini, etc; the arable crops: wheat, potato, beet, chore, Luzerne etc; arable horticulture crops, endive, cauliflower, Brussels sprouts, lettuce, broccoli, chicory, peas, beans, red cabbage, kale, etc; the garden plants Azalea, magnolia, forsythia, peony, hollyhock, laburnum, palm, wisteria, etc; fruit trees and bush: apple tree, pear tree, cherry tree, prune tree, gooseberry, black currant, blueberry, cranberry, etc; tropical fruits: banana, papaya, cassava, pineapple, avocado, mango, etc.

Preferably the plant belongs to the clade Embryophyta. Preferably, the plant is a vascular plant. In exemplary embodiments the plant is a crop plant such as Lactuca sativa (lettuce).

In other preferred embodiments, the plant belongs to the clade Angiospermae. Preferably, the plant belongs to a family selected from the group consisting of nightshades (Solanaceae), cucumber (Cucurbitaceae), roses (Rosaceae), orchids (Orchidaceae), lily (Liliaceae), composite (Asteraceae or Compositae), carnation (Caryophyllaceae), crucifers (Brassicaceae or Cruciferae), grass (Poaceae), and umbellifers (Apiaceae or Umbelliferae).

In a preferred embodiment, the plant belongs to the nightshades family (Solanaceae). Preferably, the plant belongs to the genus Solanum or Capsicum. Preferably, the plant belongs to the genus Solanum and is selected from the group consisting of tomato (S. lycopersicum), potato (S. tuberosum), eggplant (S. melongena), and pepino (S. muricatum). In other preferred embodiments, the plant belongs to the genus Capsicum and belongs to the species pepper (C. annuum), in particular sweet pepper, chili pepper, and jalapeno.

In a preferred embodiment, the plant belongs to the cucumber family (Cucurbitaceae). Preferably, the plant belongs to the genus Cucumis or Cucurbita. Preferably, the plant belongs to the genus Cucumis and is selected from the group consisting of cucumber (C. sativus), sugar melon, and gherkin (C. anguria). In other preferred embodiments, the plant belongs to the genus Cucurbita and is selected from the group consisting of C. pepo (in particular zucchini), and pumpkins (C. argyrosperma, C. digitate, C. maxima, and C. moschata).

In a preferred embodiment, the plant belongs to the rose family (Rosaceae). Preferably, the plants belong to a genus selected from the group consisting of strawberries (Fragaria), pears (Pyrus), apples (Malus), roses (Rosa), and Rubus (in particular of the subgenus Rubus, viz. blackberries).

In a preferred embodiment, the plant belongs to the orchid family (Orchidaceae). In exemplary embodiments, the plant is an ornamental plant such as an orchid, in particular of the Phalaenopsis genus, or another flowering plant such as from the genus Cymbidium.

In a preferred embodiment, the plant belongs to the lily family (Liliaceae).

Preferably, the plant belongs to the genus of tulips (Tulipa) or lilies (Lillium).

In a preferred embodiment, the plant belongs to the composite family (Asteraceae or Compositae). Preferably, the plant belongs to the genus of Chrysanthemum, Asterea, or Lactuca.

In a preferred embodiment, the plant belongs to the carnation family (Caryophyllaceae).

In a preferred embodiment, the plant belongs to the crucifers family (Brassicaceae or Cruciferae). Preferably, the plant belongs to the genus Brassica.

In a preferred embodiment, the plant belongs to the grass family (Poaceae).

Preferably, the plant belongs to the genus of Triticum, Oryza, or Zea.

In a preferred embodiment, the plant belongs to the umbellifers family (Apiaceae or Umbelliferae). Preferably, the plant is selected from the group consisting of carrots (Caucus carota), parsnip (Pastinaca sativa), anise (Pimpinella anisum), coriander (Coriandrum sativum), cumin (Cuminum cyminum). In some embodiments, the plant is not cumin.

Preferably the plant is selected from the group consisting of Phalaenopsis, Cymbidium, Chrysanthenum, Rosa, Fabaceae (preferably Phaseolus, more preferably Phaseolus vulgaris), Brassica (preferably Brassica oleracea and Brassica rapa), Cucurbita (preferably Cucurbita pepo giromontiina, Cucumus melo, and Cucumus sativus), Solanaceae (preferably Solanum or Capsicum, more preferably Solanum lycopersicum or Capsicum annuum), Vitis (preferably Vitis vinifera), Vaccinia (preferably Vaccinia corymbosum or Vacciniumcyanococcusi), and Lactuca (preferably Lactuca sativa).

As used herein, “to comprise” and its conjugations is used in its non-limiting sense to mean that items following the word are included, but items not specifically mentioned are not excluded. In addition the verb “to consist” may be replaced by “to consist essentially of” meaning that a compound or adjunct compound as defined herein may comprise additional component(s) than the ones specifically identified, said additional component(s) not altering the unique characteristic of the invention.

The articles “a” and “an” are used herein to refer to one or to more than one (i.e., to at least one) of the grammatical object of the article. By way of example, “an element” means one element or more than one element.

The word “approximately” or “about” when used in association with a numerical value (approximately 10, about 10) preferably means that the value may be the given value of 10 more or less 1% of the value.

The invention is further explained in the following examples. These examples do not limit the scope of the invention, but merely serve to clarify the invention.

### EXAMPLES

The present experiments demonstrate for the first time the effect of PTSO/PTS as a biostimulant. Despite that the growth conditions (watering, fertilization, light, temperature, air movement, air humidity) were optimal for the ornamental pot plant Phalaenopsis hybrid “Pure silk”, the administration of various amounts of PTSO/PTS resulted in higher growth rates and improved plant characteristics, as is demonstrated in example 2. In periods of high temperatures and much light in the greenhouse, the treated plants continued growing at high rates, whereas growth of untreated plants slowed down. Apparently, the PTSO treated plants were better capable of resisting periods of increased abiotic stress.

Example 3 shows that treating Chrysanthemum cuttings with various amounts of PTSO/PTS resulted in increased growth and better root development. In this experimental design, treated cuttings were compared to untreated cutting under the same conditions for optimal rooting and pregrowth of the cuttings. In this example, treatment with PTSO/PTS demonstrated increased root formation and growth of the cuttings compared to untreated cuttings under optimal conditions. Moreover, these experiments also showed an additional effect of a more efficient nutrient uptake. This indicates that the PTSO/PTS compositions used herein are biostimulants.

### Example 1 Isolation of PTSO and PTS

### Scope:

For a number of examples described herein, an aqueous extract of PTSO was used, referred to herein as PTSO EXTRACT (PE), comprising at least 56% PTSO wt % and up to 14% PTS wt %.

Study design: the order of elution of compounds according to their polarity is estimated from high-performance liquid chromatography (HPLC). The conditions for separation are determined by thin-layer chromatography (TLC) using heptane and ethyl acetate as the mobile phase. A flash column with a length of 110 cm and a diameter of 25 cm was packed with 15 kg silica (particle size 40-60 μm from ACROS Organics™) in heptane and the column was allowed to stabilise overnight. Purification was carried out by increasing the polarity gradually from 0% to 40%. The fractions of interest, PTS (=peak 6) and PTSO (=peak 7), both identified by proton nuclear magnetic resonance (¹H-NMR), started to elute after 20 litres use of mobile phase and were collected in 2 litres fraction size. The fractions were separated according to the TLC identification of each compound and the corresponding fractions for each compound (PTS or PTSO) were combined. The solvent was evaporated by rotary evaporation to obtain a purified fraction of PTS (32435-2-A) and two purified fractions of PTSO (MHA32435-2-B, MHA32435-2-C) as outlined in table 1.

The required purity of >98% was only achieved with the fraction MHA32435-2-B (=PTSO) while the fraction MHA32435-2-A (PTS) and MHA32435-2-C (=2^{nd} fraction of PTSO) showed a purity <98% and needed further purification individually by a second flash chromatography to obtain the desired purity.

The repurification of PTS (MHA32435-2-A) was carried out by packing a flash column (50 cm length and 20 cm diameter) with 2 kg silica (particle size 40-60 μm from ACROS Organics™), using ethyl acetate and heptane as the mobile phase and by increasing the polarity from 0% to 20%. The fractions of interest were collected in 250 ml fraction size, identified by TLC and combined. The solvent was evaporated by rotary evaporation to obtain PTS (EWR32514-01-1) with >98% purity.

The repurification of the impure fraction of PTSO (MHA32435-2-B) was done at the same flash column, using the same mobile phase as for MHA32435-2-A with the difference of 3 kg silica (for packing the column), increasing the polarity from 0% to 30%, and the fraction size was 100 ml. The repurification resulted in two fractions (EWR32514-02-1 and EWR32514-02-02) of PTSO with a purity >98% as outlined in table 1.

TABLE 1
Peak 6 and peak 7 purity and % recovery from PTSO EXTRACT

| | | | | | |
|---|---|---|---|---|---|
| | Weight | | | Purity | |
| Peaks | (gr) | HPLC | ¹H-nmr | (%) | % Recovery |

1st step purification of PTS (peak 6) and PTSO (peak 7PTSO EXTRACT (992 gr)

| | | | | | |
|---|---|---|---|---|---|
| 6 (=PTS) | 64 | MHA32435-2-A | MHA-32435-2-A | 93 | 6 |
| 7(=PTSO) | 651 | MHA32435-2-C | MHA-32435-2-C | 99 | 86 (from both |
| 7(=PTSO) | 198 | MHA32435-2-B | MHA-32435-2-B | 72 | fractions) |

2^{nd} step repurification of fractions relating to peak 6 and peak 7 (fr. with 72% purity)

| | | | | | |
|---|---|---|---|---|---|
| 6 (=PTS) | 46 | EWR32514-01-1 | EWR32514-01-4 | 99 | 5 |
| 7 (=PTSO) | 123 | EWR32514-02-1 | EWR32514-02-4 | 99 | 82 (from all |
| 7 (=PTSO) | 39 | EWR32514-02-02 | EWR32514-02-5 | 99 | fractions with |
| | | | | | Purity >98%) |

From this example it is demonstrated that PTSO and PTS were purified up to high purity.

For examples 2-5 described below, PTSO EXTRACT (PE) contains 56% PTSO and around 30% glyceryl polyethyleneglycol ricinoleate.

### Example 2. Treatment of Ornamental Plants

Scope: in this example the biostimulant effect of PTSO EXTRACT was demonstrated. For this purpose, the orchid Phalaenopsis “Pure silk” was selected. Growth and development of plants encompasses three stages: (1) vegetative growth, (2) flower induction, and (3) development of flower stalks.

After the treatments as mentioned below, the plants were evaluated at the end of the flower induction period. At the time of sale flowering of the plants were evaluated.

### Plant Cultivation Procedure

Plants of Phalaenopsis “pure silk” (Floricultura B.V.) were produced from meristems and pregrown. Upon delivery at the Phalaenopsis grower the plants were processed according to the following procedure. The plants were potted up in a transparent 12 cm pot in middle-sized bark (Supplier: Bas van Buuren B.V., De Lier), cultivated for 30 weeks at 29° C., and showered every 5 days with water plus fertiliser (100 litres per m²) (EC 1.1).

If needed, the plants were exposed to artificial light (from 7:00 a.m. until 6:00 p.m.). For flower induction, the plants were cooled down and cultivated for two months at 19° C. Hereafter, the plants were kept for 3-4 months at 20-25° C., and were optionally exposed to artificial light if needed. In this way, flowering plants were obtained that had the appropriate size in line with market demands.

In July 2020 young Phalaenopsis plants were potted up in bark. July was a hot and sunny month, and despite that the grower was using shadowing screens, the plants showed hanging, thin leaves that had a dark green/reddish colour, with little growth progress. This indicated that the plants suffered from abiotic stress. The number of roots and root growth, was monitored by visual inspection through the transparent pots. Considerable variations in number of roots and root growth were observed within the plant population.

The following experimental design was set up with the objective to determine the sensibility of the plants for various dilutions and number of treatments by PTSO EXTRACT. Areas of 1 m² (containing about 100 plants) were treated with dilutions of PTSO/PTS containing extract and were manually showered by dilutions in water (10 L/m²), as follows. Manual watering with the diluted PTSO EXTRACT took place directly after the regular 5 day's showers. In this way, the water content of the root substrates of the control and treated plants were about the same.

Treatment 1: 2× treated with 1,000× dilution of PTSO EXTRACT in a feed solution (EC 1.1), supplied every other watering (interval was 10 days);

Treatment 2: 2× treated with 2,500× dilution of PTSO EXTRACT in a feed solution (EC 1.1), supplied every other watering (interval was 10 days);

Treatment 3: 8× treated with 1,000× dilution of PTSO EXTRACT in a feed solution (EC 1.1), supplied every other watering (interval was 10 days);

Treatment 4: 8× treated with 2,500× dilution of PTSO EXTRACT in a feed solution (EC 1.1), supplied every other watering (interval was 10 days); After the treatments, the treated plants undergo the same cultivation procedure as the control plants, i.e. the untreated plants.

After 36 weeks the plants were scored on the features as follows.

Differences between plants were expressed in terms of amount of roots, interrupted root growth, progressive leaf development, number and length of leaves, plant and bark quality (assessed by colour and water retention, i.e. estimated weight).

Evaluation went as follows: from the Control plants, the largest and the smallest plant were selected. The largest was rated 5, and the smallest 1.

The same scoring procedure was followed with regard to the rating of root formation: the plant with the most roots is rated 5, and the one with the fewest roots is rated 1.

The length of the largest fully developed leaf was measured with a tape measure.

“6-7” leaves means that 6 leaves were already fully developed, and a seventh leaf was still growing.

“Leaf thickness” was scored by the resistance of the leaf when it was bowed by hand.

“Bark quality” was scored by judging the degree of composition that has taken place. The wetter and muddier the bark was, the lower the score was.

“Progressive growth” is an estimate of the extent to which a plant's leaves are larger than the previous leaf. In particular, the last fully developed leaf was compared with the penultimate leaf developed.

“Plant size was scored as follows: the bigger the plant, the higher the score.

For “Plant characteristics” the main focus was on the size of the plant.

The control plants were rated from 1 to 5, and compared to treated plants. If any one of the treated plants had developed better with regard to an assessment criterion, they can score above 5. The plants with the worst “Plant characteristics” was rated “1”, and the plants with the best characteristics was rated 5.

### Results and Discussion

The averages of the measurements are summarised in Table 2, and are based on the raw data. The data were collected 36 weeks after the treatments: the plants had just left the refrigerated part of the greenhouse for two weeks for flower induction.

TABLE 2
Calculated averages of the observations.

| | Number | | | | | | Leaf | | | |
|---|---|---|---|---|---|---|---|---|---|---|
| Plant | of rated | | Bark | Leaf | Progressive | Number | size | Plant | Plant | |
| group | plants | Roots | quality | thickness | growth | of leaves | (cm) | size | characteristics | Remarks |
| Control, | 50 | 3.42 | 3.18 | 3.66 | 4 | 6.34-7.34 | 22.1 | 3.88 | 1 | Weak |
| standard | | | | | | | | | | shine on |
| treatment | | | | | | | | | | leaves |
| 2x treated | 50 | 2.9 | 2.72 | 4.82 | 4.92 | 6.9-7.9 | 22.6 | 4.22 | 2 | Strong |
| with 1,000x | | | | | | | | | | shine on |
| dilution. | | | | | | | | | | leaves |
| 2x treated | 25 | 3.08 | 3 | 5.84 | 5.64 | 7.32-8.32 | 22.7 | 5.48 | 3 | Strong |
| with 2,500x | | | | | | | | | | shine on |
| dilution | | | | | | | | | | leaves |
| 8x treated | 25 | 4.2 | 2.84 | 5.96 | 5.72 | 7.12-8.12 | 23.28 | 5.44 | 4 | Strong |
| with 1,000x | | | | | | | | | | shine on |
| dilution | | | | | | | | | | leaves |
| 8x treated | 25 | 3.6 | 2.88 | 4.52 | 5.72 | 6.9-7.9 | 23.7 | 5.72 | 5 | Strong |
| with 2,500x | | | | | | | | | | shine on |
| dilution | | | | | | | | | | leaves |

The plants that are treated twice with the 1,000× and 2,500× dilutions of PTSO EXTRACT showed significantly less root growth than the control. Despite that the roots of these treated plants were less developed than those of the control plants, the roots of the treated plants enable the plant to grow faster.

Similar, but more pronounced observations were done for the plants that were treated 8 times with both dilutions: the size of the plants were largest of all treatments. Additionally, the roots showed a considerably better root development.

Furthermore, there were not only more roots, but the roots had larger growth tops and were thicker. It was concluded that the largest effect on the Phalaenopsis plant was the treatment with the 1,000× dilution that was applied 8 times.

As is shown in table 1, the quality of the root substrate bark was also scored. Bark slowly decomposes by microbial activity during the cultivation of plants. When the bark is decomposed, it changes into a wet anaerobic substance that could result in die off of roots. While Table 1 shows a slightly lower rating of bark quality for the treated plants (2.72-3) as compared to the control plants (3.18), these differences are so small that no adverse effects were expected for the treated plants.

### Conclusions

A very pronounced effect of PTSO EXTRACT on the scored plant properties was demonstrated. Growth stimulation was observed compared to the control plants.

Since no plant growth hormones were present in the PTSO EXTRACT, this composition falls under the category of Biostimulants. During the test period it was clear that the plants were not capable of growing at the maximal growth rate during the experiments that resulted in abiotic stress (there were periods of drought, heat and very much light). In the experiments it was shown that PTSO EXTRACT is capable to compensate for the abiotic stress.

The fertilising conditions were exactly the same for all plants, yet more plant biomass was formed together with improved plant characteristics in the plants treated with PTSO EXTRACT. This indicates that the nutrient use efficiency was higher for the plants treated with PTSO EXTRACT.

Another interesting observation was that the plants had a very clear shine on the leaves. This was attributed to the formation of a thicker layer of wax on the leaf and is considered as an indication of better plant health. Without wishing to be bound by theory, it is believed that a thick layer of wax typically decreases water evaporation from the upper leaf surface, which contributed to the decrease in abiotic stress.

The observations made after the treatments on Phalaenopsis in which PTSO EXTRACT was applied two times, have shown that this was sufficient to induce a long term effect over a cultivation time of more than 6 months, which was very surprising.

Flowering of the plants was unaffected by the treatments and the plants represented an excellent commercial product. No deviations have been observed in terms of wilting, abnormal flowers, stalk shape or size.

In this example it is clearly shown that the PTSO EXTRACT is a powerful biostimulant.

### Example 2b. Treatment of Phalaenopsis Plants

Scope: in this example the biostimulant effect of PTSO EXTRACT was demonstrated on survival after repotting and flower stalk production during the cultivation trajectory. For this purpose, various Phalaenopsis hybrids were selected. Growth and development of plants encompasses three stages: (1) vegetative growth, (2) flower induction, and (3) development of flower stalks. The same grow-up regime was followed as described in example 2. After the treatments as mentioned below, the plants were evaluated at failure after repotting and the number of flower stalks at the end of the cultivation cycle.

Scope: during grow up of Phalaenopsis, the grower is regularly confronted with significant loses after transplanting. This may count up to 10% dependent on the size, condition and genetic background of the hybrid. In this example it was demonstrated that PTSO EXTRACT strongly decreases the failure of (young) Phalaenopsis plants after transplanting and increases the number of flower stalks prior to sale of the plants. For this purpose, various hybrids of Phalaenopsis were grown from meristems and pregrown in 70 hole trays until a diameter of 5 cm with Floricultura. Hereafter the plants were delivered at the grower and were transplanted from 70 hole trays to 45 hole trays with pea/cocos plugs as a substrate (Xcellent Plug Quick plug B.V., Monster, The Netherlands).

Repotting of a plant is considered as a stressful period. It is inevitable that roots are damaged and directly after repotting the root substrate (bark) often has not the optimal properties in terms of moisturising and capillarity. The plants experience this as drought, a kind of abiotic stress.

After repotting, the plants were treated with 2500× diluted PTSO EXTRACT weekly (800 ml/ha). After 26 weeks after repotting 13,000 plants were checked on failure (=complete die-off) and compared to 13,000 untreated plants. The results are presented in table 2a.

TABLE 2a
Failure of some Phalaenopsis hybrids
of untreated and treated plants.

| Phalaenopsis hybrid | Treatment | % failure |
|---|---|---|
| Joyride | Treated | 4.8 |
| | None | 17.9 |
| Angle Eyes | None | 4.1 |
| | Treated | 3.8 |
| Coco 4 | None | 3.2 |
| | Treated | 2.8 |
| Donau | None | 6.7 |
| | Treated | 2.6 |
| Gold Baby | None | 7.1 |
| | Treated | 4.5 |
| LaPaz | None | 12.6 |
| | Treated | 5.3 |
| Lumion | None | 3.1 |
| | Treated | 1.7 |
| Murcia | None | 4.8 |
| | Treated | 2.0 |
| Prince | None | 6.6 |
| | Treated | 0.5 |
| Serena | None | 7.9 |
| | Treated | 7.1 |

Failure means: completely die off.

From these results it is clear that treatment with PTSO-Extract has a strong positive effect on survival after a repotting that may be considered as a stressful handling.

After 26 weeks, the plants were potted up in transparent 12 cm pots and cultivated in the same cultivation regime as is indicated in example 2.

The hybrids Mekong, Orinoco, Ferrara and Goya were evaluated on gowth as indicated in Example 2, and with all these hybrids growth stimulation was observed (raw data are not shown here).

After flower stalk induction in a refrigerated room the number of flower stalks are counted per plant. For that purpose 800 plants were evaluated per hybrid (see table 2b).

TABLE 2b
Average number of flower stalks of treated and untreated plants
of various Phalaenopsis hybrids after bloom induction.

| | | Average number of |
|---|---|---|
| Phalaenopsis hybrid | Treatment | flower stalks per plant |
| Ferrara | None | 1.7 |
| | Treated | 2.0 |
| Mekong | None | 2.5 |
| | Treated | 2.7 |
| Narbonne | None | 2.0 |
| | Treated | 2.7 |

From table 2b it is clear that the number of formed flower stalks is larger after treatment than the control group when cultivated under the same conditions. This makes the PTSO-Extract a biostimulant.

### Example 3. Treatment of Chrysanthemum Cuttings

PTSO EXTRACT was tested on biostimulant activity as is defined in Regulation 2019/1009 of the EU. The results were checked for the occurrence of the 4 mentioned properties on rooting and growth of Chrysanthemum cuttings. The experiments were performed by an independent research institution Vertify. The Netherlands.

Scope: in this example the effect of PTSO EXTRACT was demonstrated as a biostimulant. For this purpose, cuttings of the Chrysanthemum variety “Chic” were selected. Chrysanthemum cuttings were planted in fertilised standard potting soil in a flat plant container (a “plot”. Each plot consisted of 30 plants).

With all treatments, three repeated treatments were done on the roots as indicated below with a 1-week interval. Temperature, light control and relative humidity in the greenhouse compartment were recorded with a climate computer (Sercom).

After the treatments the plants were evaluated at the end of the flower induction period. The last assessment was performed 13 days after the last treatment. The cuttings were judged on root formation, length of the stalks, and overall condition of the plant.

### Plant Cultivation Procedure

Rooted Chrysanthemum “Chic” cuttings with the same length were delivered by Royal van Zanten, the Netherlands.

The trial was done under controlled conditions in greenhouse facilities. Crates of 40×60 cm and 10 cm depth were filled with a fertilised standard potting soil (organic medium) in which the Chrysanthemum cuttings were planted. Each plot consisted of 2 crates with 15 plants each (30 plants per plot).

The treatments (a specific dilution) existed of three applications with intervals of 1 week, the first application was done at 1 week before transplant (rooting phase), a second application was done at transplant. A final application was done 1 week after transplant. Randomisation of the treatments takes place in the test greenhouse, and where the plants are positioned is determined using Genstat software. Statistical analysis of trial results is done with the same software.

Details are given in de result section of this example.

Temperature and relative humidity in the greenhouse compartment were recorded with the climate computer and were set at 23° C. and 50% respectively.

Applications targeting roots were done as drench or spray. The first application on roots was done by drenching the plants in the solutions during approx. 15 minutes.

The untreated plots were drenched in water. The cuttings were kept in crates with their roots in a layer of water until transplanting them into crates with soil.

Further applications were done by spraying the solutions on the soil, followed by a gentle rain to incorporate the products in the rooting zone. The application and assessment details are summarized in Table 3.

TABLE 3
Experimental time schedule.

| Handlings | Data (DA: Days after) |
|---|---|
| Planting | Day 7 |
| Application dates | Day 0 (A) |
| | Day 7 (B) |
| | Day 13 (C) |
| Assessment dates | Day 7 (at transplant; 0 DA-B)* |
| | Day 13 (0 DA-C) |
| | Day 19 (6 DA-C) |
| | Day 26 (13 DA-C) |

DA: Days after.

The treatments are summarized in Table 4. Previcur Energy is a fungicide, and Trianum-P is a biological fungicide.

TABLE 4
Treatment list.

| Experimental | |
|---|---|
| number | Treatment |
| 1 | Untreated |
| 2 | Previcur Energy (1 L/ha) |
| 3 | Trianum-P (2.5 kg/ha) |
| 4 | PTSO EXTRACT; 1:1,000 dilution |
| 5 | PTSO EXTRACT 1:2,500 dilution rate |
| 6 | PTSO EXTRACT; 1:5,000 dilution rate |
| 7 | PTSO EXTRACT; 1:10,000 dilution rate |
| 8 | PTSO EXTRACT; 1:50,000 dilution rate |

At each assessment date, the height of 10 centre plants per plot were measured.

Additional assessments on general crop vigor were done. General crop vigor was recorded in 1-10 index scale (1=very poor crop vigor; 10=excellent (above normal) crop vigor) and is based on the impression of the general health. At the last assessment date, fresh weight of the above ground plant mass was measured.

Rooting density at the bottom side of the crates was recorded. For this purpose, the crates were turned over and the percentage ofroots that covers the underside of the bottom were estimated.

Statistical analysis was done with Genstat (LSD test at 95%). In the table P means probability. When P has a value of 0.05 or less, the difference between two treatments is statistically significant. The least significant difference (lsd) is the smallest difference between significant different treatments at 95% (P=0.05).

Values indicated with the same letter do not significantly differ (P=0.05). 1 litre PTSO EXTRACT was dissolved into 1,000 litres of water (dilution rate 1:1,000) and this volume of 1,001 litres was sprayed onto the soil with a surface of 1 ha).

### Results

Results after analysis of the crop height are summarized in Table 5.

TABLE 5
Development of the crop height with the various treatments as a function of time. The columns
with the crop height indicate the statistic groups after LSD statistical analysis.

| | | | Crop height (cm) | | | |
|---|---|---|---|---|---|---|
| Treatment | | Application | 0 DA-B | 0 DA-C | 6 DA-C | 13 DA-C |
| 1 Untreated | | — | 12.9 b | 18.5 bc | 29.8 bc | 51.5 bc |
| 2 | Previcur Energy (1 L/ha) | Soil | 15.0 e | 20.3 e | 31.6 e | 54.8 d |
| 3 | Trianum-P (2.5 kg/ha) | Soil | 13.0 b | 18.1 b | 29.2 b | 50.8 b |
| 4 | PTSO EXTRACT; 1:1,000 | Soil | 11.8 a | 16.0 a | 26.8 a | 48.7 a |
| | rate (1 L/ha) | | | | | |
| 5 | PTSO EXTRACT; 1:2,500 | Soil | 13.6 bc | 18.9 c | 30.3 bcd | 52.4 bc |
| | rate (0.4 L/ha) | | | | | |
| 6 | PTSO EXTRACT; 1:5,000 | Soil | 13.9 c | 19.0 cd | 30.4 cde | 52.0 bc |
| | rate (0.2 L/ha) | | | | | |
| 7 | PTSO EXTRACT; 1:10,000 | Soil | 14.7 de | 19.7 de | 31.1 de | 53.2 cd |
| | rate (0.1 L/ha) | | | | | |
| 8 | PTSO EXTRACT; 1:50,000 | Soil | 14.0 cd | 19.0 cd | 30.2 bcd | 53.4 cd |
| | rate (0.02 L/ha) | | | | | |

| | | | | |
|---|---|---|---|---|
| P | <0.001 | <0.001 | <0.001 | <0.001 |
| LSD | 0.7 | 0.8 | 1.2 | 2.0 |

With PTSO EXTRACTat the highest concentration (1:1000), at transplant 0 DA-B, plants were significantly shorter compared to all other treatments. At a concentration of 1:2,500, no adverse effect of the drench treatment on crop height was found.

After repeated applications and during the trial period, the differences remained visible. A dose response was constructed with PTSO EXTRACT. The tallest plants were measured at concentrations 1:10,000 and 1:50,000.

General crop vigor was recorded in 1-10 index scale (1-very poor crop vigor; 10=excellent (above normal) crop vigor). Crop vigor is a subjective measurement on plant color and shape. Results are summarized in Table 6.

TABLE 6
Crop vigor.

| | | Appli- | Vigor (1-10 scale¹) | | |
|---|---|---|---|---|---|
| Treatment | | cation | 0 DA-C | 6 DA-C | 13 DA-C |
| 1 | Untreated | — | 7.2 | 7.4 | 7.4 |
| 2 | Previcur Energy (1 L/ha) | Soil | 7.4 | 7.7 | 7.9 |
| 3 | Trianum-P (2.5 kg/ha) | Soil | 6.9 | 7.1 | 7.5 |
| 4 | PTSO EXTRACT; | Soil | 4.9 | 5.2 | 6.1 |
| | 1:1,000 rate (1 L/ha) | | | | |
| 5 | PTSO EXTRACT; | Soil | 7.0 | 7.7 | 7.9 |
| | 1:2,500 rate | | | | |
| 6 | PTSO EXTRACT; | Soil | 7.0 | 7.4 | 7.6 |
| | 1:5,000 rate | | | | |
| 7 | PTSO EXTRACT; | Soil | 7.9 | 7.8 | 7.8 |
| | 1:10,000 rate | | | | |
| 8 | PTSO EXTRACT; | Soil | 7.0 | 7.4 | 7.4 |
| | 1:50,000 rate | | | | |

¹1 = very poor crop vigor; 10 = excellent (above normal) crop vigor.

On general crop vigor, only PTSO EXTRACT at a concentration of 1:1,000 performed less compared to all other treatments. At the last assessment date (19 days after transplant), fresh weight of the above ground plant mass was measured. Rooting density at the bottom side of the crates was recorded. Results are summarized in Table 7.

TABLE 7
Fresh weight and rooting (soil applications).

| | | | 19 days after transplant | |
|---|---|---|---|---|
| | | | Fresh | Rooting |
| | | Appli- | weight | density |
| Treatment | | cation | (g/plot) | (%) |
| 1 | Untreated | — | 1097.8 | 36.0 |
| 2 | Previcur Energy (1 L/ha) | Soil | 1161.2 | 36.0 |
| 3 | Trianum-P (2.5 kg/ha) | Soil | 1124.6 | 39.0 |
| 4 | PTSO EXTRACT; | Soil | 1018.0 | 46.0 |
| | 1:1,000 rate (1 L/ha) | | | |
| 5 | PTSO EXTRACT; | Soil | 1123.8 | 44.0 |
| | 1:2,500 rate | | | |
| 6 | PTSO EXTRACT; | Soil | 1137.4 | 42.0 |
| | 1:5,000 rate | | | |
| 7 | PTSO EXTRACT; | Soil | 1131.6 | 36.0 |
| | 1:10,000 rate | | | |
| 8 | PTSO EXTRACT; | Soil | 1140.0 | 40.0 |
| | 1:50,000 rate | | | |
| | | P | 0.004 | |

The fresh weight of the above ground plant mass of plants treated with PTSO EXTRACT at 1:1,000 concentration, applied as soil treatment, was less compared to the other treatments. Although rooting at transplant seemed to be affected, the final results obtained 19 days after transplant, showed no adverse effects on rooting. With this treatment the rooting density was even higher compared to the other treatments. After all soil treatments with PTSO EXTRACT, the rooting density was equal (entry 7 in Table 7) or even higher (entries 4-6, and 8 in Table 7) as compared to the untreated plots and also both references Previcur Energy and Trianum-P.

After the first application during the rooting phase (drench) with PTSO EXTRACT at the highest concentration (1:1,000), hardly any roots were noted. The plants were also shorter compared to the untreated plots. Also at a concentration of 1:2,500 of PTSO EXTRACT fewer roots were observed compared to the untreated and reference plants Previcur Energy and Trianum-P.

After repeated applications and during the trial period, after soil applications a dose-response relationship was observed for treatments with PTSO EXTRACT. The tallest plants were measured at the lower concentrations of PTSO EXTRACT, viz. 1:10,000 and 1:50,000. At these concentrations, the plants were significantly taller compared to the untreated plants until 2 weeks after planting. When subjected to the highest concentration of PTSO EXTRACT, viz. 1:1,000, plants were smaller compared to all other treatments. The differences were also reflected by fresh weight at the last assessment date (19 days after transplant).

Although during treatments with PTSO EXTRACT at 1:1,000 concentration, rooting during the rooting phase (drench) was affected, and plants were smaller compared to those subjected to other treatments, no adverse effects on final rooting were found. After treatment with PTSO EXTRACT at 1:1,000 concentration, rooting at 19 days after transplant was numerally even better compared to the other treatments.

with the other tested concentrations. Furthermore, PTSO EXTRACT when applied as soil treatment resulted in numerally better rooting compared to the untreated plots and also both references Previcur Energy and Trianum-P.

Chrysanthenum is a cut flower that is produced in large quantities and it is retailed by weight. In this example it is clearly demonstrated that said compositions result in more weight and is therefore beneficial for the horticulturist.

From these experiments it is also clear that the right dosages of this biostimulant must be dosed in order to obtain the biostimulating effects.

### Example 4. Treatment of Lettuce Seeds and Seedlings

Seeds of the lettuce (Lactuca sativa) variety “volare” were obtained from Enza Zaden, and Trianum P from Bayer AG, Crop Science Division.

Seeding boxes (45 with 30 cm, 8 cm depth, 9 litres of soil/seeding box) were filled with standard seeding soil (BVB Substrates) that consisted of fine organic medium in which lettuce was seeded. The obtained seeding soil was fertilized by the producer, no additional fertilisation was performed during the experiment. Each plot consisted of 1 seeding box with 50 seeds and planted at a depth of 2 cm. The seeds were treated close before seeding as indicated in table 8.

TABLE 8
Treatment list.

| No. | Treatment, drenched into: |
|---|---|
| 1 | Untreated |
| 2 | Vigor Seed; 10 g/hL |
| 3 | PE; 1:5,000* (approximately 112 mg PTSO/L) |
| 4 | PE; 1:10,000* (approximately 56 mg PTSO/L) |
| 5 | PE; 1:25,000* (approximately 22 mg PTSO/L) |
| 6 | PE; 1:50,000* (approximately 11 mg PTSO/L) |

*Dilution rate
PE = PTSO Extract

The solutions with PTSO EXTRACT were prepared with tap water. Applications were done by drenching the seeds in the prepared solutions for 10 minutes. After drenching the seeds were dried to the air dried and seeded. The untreated seeds were drenched in water. “Vigor seed” was used as a reference agent. The boxes were covered with a lid until germination. Temperature was set at 21° C., an air humidity varied between 70-95%. Light exposure was realised by three 25 Watt LED-tubes at 30 cm distance from the plants (50 μmol). After germination the lid was removed.

Randomisation of the treatments was done manually. Statistical analysis of trial results is done with Genstat software. Temperature, light control and relative humidity in the climate were controlled and recorded with a climate computer (Sercom).

Trial details are summarized in table 9.

TABLE 9
Trial details.

| | |
|---|---|
| Location: | The Netherlands |
| Crop: | Lettuce |
| Variety: | Volare |
| TSW * | 1.446 g |
| Seedbatch | 6034072 |
| Date of seeding | Day 0 |
| Assessment dates | Day 4 (4 DA-S**; at germination) |
| | Day 7 (7 DA-S) |
| | Day 12 (12 DA-S) |
| | Day 21 (21 DA-S) |
| | Day 28 (28 DA-S) |

* TSW: Thousand seed weight
**DA-S: Days After Seeding.

When all seeds had fully germinated, the plants were scored as normal, small or abnormal (plants with malformed cotyledons or leaves), general crop vigor was recorded in 1-10 index scale. At the last assessment date (4 weeks after planting the seeds,) fresh weight of the above ground plant mass was measured.

At each assessment date the numbers of germinated plants were counted per plot. After full germination, the plants were scored as normal, small or abnormal (plants with malformed cotyledons or leaves). Additionally, general crop vigor was recorded in 1-10 index scale (1=very poor crop vigor; 10=excellent (above normal) crop vigor). At the last assessment date, fresh weight of the above ground plant mass were measured. Statistical analysis was done with Genstat (LSD test at 95%). In the table P means probability. When P has a value of 0.05 or less, the difference between two treatments is statistically significant. The least significant difference (lsd) is the smallest difference between significant different treatments at 95% (P=0.05). Figures with the same letter do not significantly differ (P=0.05). For example, in the treatments at 12 DA-S, no statistically significant difference was observed between untreated plants (“a”) and Vigor Seed (“a”), PE; 1:50,000 (“a”), or PE; 1:25,000 (“ab”); but statistically significant differences were observed between untreated plants (“a”) and PE; 1:10,000 (“bc”) and PE; 1:5,000 (“c”). Similarly, the PE; 1:5,000 (“c”) treatment different significantly from all other treatments except PE; 1:10,000 (“bc”).

### Results and Discussion

At each assessment date the numbers of germinated plants were counted per plot. When all plants had fully germinated, the plants were scored into the categories normal, small or abnormal (abnormal plants have malformed cotyledons or leaves). Results are summarized in tables 10 and 11.

TABLE 10
Germinated plants.

| | | # germinated plants per plot (50 plants per plot) | | | | | | | | | |
|---|---|---|---|---|---|---|---|---|---|---|---|
| Treatment | | 4 DA-S¹ | | 7 DA-S¹ | | 12 DA-S¹ | | 21 DA-S¹ | | 28 DA-S¹ | |
| 1 | Untreated | 47.3 | a | 49.3 | a | 44.8 | a | 44.5 | a | 44.5 | a |
| 2 | Vigor Seed; 10 g/hL | 45.0 | a | 49.3 | a | 45.3 | a | 45.3 | a | 45.3 | a |
| 3 | PE; 1:5,000 | 48.0 | a | 50.0 | a | 49.5 | c | 49.5 | c | 49.5 | c |
| 4 | PE; 1:10,000 | 45.3 | a | 49.3 | a | 48.8 | bc | 48.8 | bc | 48.8 | bc |
| 5 | PE; 1:25,000 | 46.0 | a | 48.5 | a | 46.8 | ab | 46.5 | ab | 46.5 | ab |
| 6 | PE; 1:50,000 | 46.3 | a | 49.0 | a | 45.0 | a | 45.0 | a | 44.8 | a |

| | | | | | |
|---|---|---|---|---|---|
| P | 0.609 | 0.451 | 0.002 | 0.003 | 0.002 |
| LSD | 4.1 | 1.5 | 2.5 | 2.5 | 2.5 |

¹DA-S = Days After Seeding.

TABLE 11
Normal plants (germinated-small-abnormal).

| | | # normal plants per plot (50 plants per plot) | | | | | | | | | |
|---|---|---|---|---|---|---|---|---|---|---|---|
| Treatment | | 4 DA-S* | | 7 DA-S | | 12 DA-S | | 21 DA-S | | 28 DA-S | |
| 1 | Untreated | 47.3 | a | 48.5 | a | 43.8 | a | 44.3 | a | 44.0 | a |
| 2 | Vigor Seed; 10 g/hL | 45.0 | a | 47.5 | a | 45.0 | ab | 45.3 | a | 44.8 | a |
| 3 | PE; 1:5,000 | 48.0 | a | 49.0 | a | 48.8 | c | 49.0 | b | 49.0 | b |
| 4 | PE; 1:10,000 | 45.3 | a | 47.5 | a | 47.5 | bc | 48.3 | b | 48.3 | b |
| 5 | PE; 1:25,000 | 46.0 | a | 47.8 | a | 46.0 | abc | 46.3 | ab | 46.3 | ab |
| 6 | PE; 1:50,000 | 46.3 | a | 48.3 | a | 44.5 | ab | 45.0 | a | 44.8 | a |

| | | | | | |
|---|---|---|---|---|---|
| P | 0.609 | 0.681 | 0.025 | 0.012 | 0.008 |
| LSD | 4.1 | 2.3 | 3.0 | 2.8 | 2.8 |

*DA-S = Days After Seeding.

Only some minor differences were found between numbers of germinated plants and numbers of normal plants, indicating that only few small or abnormal plants were found.

During germination and at full germination, no significant differences were found between treatments on both numbers of germinated and numbers of normal plants. The germination level with all treatments was very good. The treatments did not affected germination or quality of the seedlings either positive or negative.

At 12 days after seeding and later assessment dates, fall out of plants was found, specifically in the untreated, vigor seed and lower PE concentrations. No explanation was found: plant pathogens or other plaques were not detected.

Significant differences were found between the treatments. A dose response was constructed with PE. With PE at the highest concentration (1:5,000), no fall out of plants was found. At the lowest concentration (1:50,000), PE was comparable to the untreated plots.

With the lower dilutions of PE (i.e. PE at the higher concentrations), when applied as drench application on seeds, the seedlings were more resilient compared to seedlings from untreated seeds. Significant effects were measured at concentrations 1:5,000 and 1:10,000. With Vigor Seed, no effects were observed with the untreated plots.

General crop vigor was recorded in 1-10 index scale (1-very poor; 10=excellent (above normal). Crop vigor is an estimation on plants, in this case color and shape (table 12).

TABLE 12
Estimation of crop vigor with the various dilutions of PE.

| | Vigor (1-10 scale) | | | | |
|---|---|---|---|---|---|
| | 4 | 7 | 12 | 21 | 28 |
| Treatment | DA-S* | DA-S | DA-S | DA-S | DA-S |
| 1 Untreated | n.d. | 7.9 | 7.6 | 7.6 | 8.0 |
| 2 Vigor Seed; 10 g/hL | n.d. | 7.8 | 7.8 | 7.6 | 7.9 |
| 3 PE; 1:5,000 | n.d. | 8.0 | 8.0 | 8.6 | 8.8 |
| 4 PE; 1:10,000 | n.d. | 8.1 | 8.0 | 8.5 | 8.5 |
| 5 PE; 1:25,000 | n.d. | 8.0 | 7.8 | 8.1 | 7.9 |
| 6 PE; 1:50,000 | n.d. | 7.9 | 7.8 | 8.1 | 8.1 |

*DA-S = Days After Seeding.

At 1:5,000 and 1:10,000 dilution rate resulted in some better vigorous plants compared to lower concentration, Vigor Seed and the untreated plots.

At the last assessment date (28 days after seeding; 24 days after germination), fresh weight of the above ground plant mass was measured. The results are summarized in table 13.

TABLE 13
Fresh weight of the various plots.

| | Fresh weight |
|---|---|
| Treatment | (g/plot) |
| 1 Untreated | 217.5 |
| 2 Vigor Seed; 10 g/hL | 190.4 |
| 3 PE; 1:5,000 | 240.9 |
| 4 PE; 1:10,000 | 242.4 |
| 5 PE; 1:25,000 | 220.2 |
| 6 PE; 1:50,000 | 231.4 |

All treatments with PTSO EXTRACT dilutions lead to an increase in fresh weight over control. Conclusive, the germination level with all treatments was very good. The treatments had not negatively affected germination or initial quality of the seedlings. Seedlings germinating from seeds treated with PE 1:5,000 and 1:10,000 were significantly more resilient compared to seedlings from untreated seeds and Vigor Seed. Less fall out of plants (f 1% versus f 10% untreated) was found, while also crop vigor was better compared to untreated plots. Also the weight of the crop measured 28 days after seeding was more when treated with PE 1:5,000 and 1:10,000 and resulting in 11% more crop weight versus untreated and 26% more than benchmark Vigor Seed. The plant size was 4-6 full-grown leaves on that moment.

With the reference agent Vigor Seed, no effects were measured compared to the untreated plots.

### Conclusion

The present example demonstrates that the use of PTSO EXTRACT leads to larger heads of lettuce and greater yield per input of nutrients (i.e., a marker of nutrient utilization efficiency), as well as increased crop vigor, providing further evidence of the biostimulant effect of the compounds disclosed herein.

### Example 5. Treatment of Tomato Plants

Scope: in this example the biostimulant effect and the manner of administration of PTSO EXTRACT (PE) was demonstrated. For this purpose, the commercial tomato production race “Xandor” was selected.

### Plant Cultivation Procedure

The tomato race “Xandor”, from Axia seeds, The Netherlands was used. The tomato plants were pregrown at a size of 60 cm.

Tomato plants of the race “Xandor” were precultivated and the plants were placed on rock wool mats (Grodan (ROCKWOOL B.V.) in a greenhouse in spring. The plants were fed and on-line adjusted dependent on the actual evaporation and weather by a computer system delivered by Priva B.V. All the nutrients in the plant feed were supplied in excess and the composition was sampled weekly and checked on nutrient limitations. The EC value was maintained between 2.3-3.0 and the pH was kept at 5.4 and continuously corrected. In table 14 the growth parameters are presented that were adjusted, monitored and controlled. Table 14 indicates the settings, but the actual values vary considerably because of the variable changes in weather conditions during the day.

TABLE 14

| Growth parameter | setting | |
|---|---|---|
| Day temperature | 20° | C. |
| Night temperature | 16-18° | C. |

| | |
|---|---|
| Relative air humidity | 70% |
| Light exposure | Day light |
| Artificial light | none |
| Feed drain | 15-25% |

TABLE 15
Experimental time schedule.

| Handlings | Data (DA: Days after) |
|---|---|
| Planting | Early spring; Day 0 |
| Application dates | T1: Day 85 |
| | T2: Day 91 |
| | T3: Day 98 |
| | T4: Day 105 |
| | T5: Day 112 |
| | T6: Day 119 |
| | T7: Day 12 |
| | T8 Day 133 |
| | T9: Day 141 |
| | T10: Day 147 |
| Assessment dates | Assessment of the harvest was |
| | performed weekly. |
| | Crop scoring was performed 5 |
| | times, namely: |
| | Day 124 |
| | Day 131 |
| | Day 142 |
| | Day 152 |
| | Day 176 |

The treatments are summarized in Table 16. Serenade is a fungicide that is often applied in tomato crops.

TABLE 16
Treatment list.

| Experimental | |
|---|---|
| number | Treatment |
| 1 | Untreated |
| 2 | PTSO EXTRACT; 1:10,000 dilution, spray on leaf |
| 3 | PTSO EXTRACT 1:25,000 dilution rate, spray on leaf |
| 4 | PTSO EXTRACT; 1:50,000 dilution rate, spray on leaf |
| 5 | Serenade (2.8 ml/l)) |
| 6 | PTSO EXTRACT; 1:10,000 dilution, poured on mat |
| 7 | PTSO EXTRACT 1:25,000 dilution rate, poured on mat |
| 8 | PTSO EXTRACT; 1:50,000 dilution rate, poured on mat |

Each treatment consists of a group of 13 plants.

The applied spray volumes were 150 ml/m2 each time, in case of administering on the mat 100 ml/plant was dosed. Additional assessments on general crop vigor were done. General crop vigor was recorded in 1-10 index scale (1=very poor crop vigor; 10=excellent (above normal) crop vigor) and is based on the impression of the general health. Crop vigor criteria were “the general condition of the plants (freshness of the plant, firmness of the leaves, healthy leaves)” “tomato head quality” (diameter of the head, thickness of the stalk and were rated from 1 (very poor) to 10 (excellent) and colour of the leaves (rated from 1 (yellow)-5 green). Furthermore, once per week the ripe tomatoes were harvested and measured. Statistical analysis was done with Genstat (LSD test at 95%). In the table P means probability. When P has a value of 0.05 or less, the difference between two treatments is statistically significant. The least significant difference (lsd) is the smallest difference between significant different treatments at 95% (P=0.05). Values indicated with the same letter do not significantly differ (P=0.05).

After planting on the mats crop development took place as was expected for this race. On Day 124 the assessments were started. The results are presented in tables 17-20.

Table 17 demonstrates that the PTSO-EXTRACT does not have a negative effect on cumulative tomato production and at a dilution of 1:10,000 slightly increased cumulative tomato production. A number of plant quality parameter were scored, including tomato head quality (Table 18), plant health condition (Table 19) and crop colour (Table 20). All dilutions of the PTSO-EXTRACT showed improved quality with respect to tomato heads, plant condition and plant colour.

The fertilising conditions were the same for all plants, yet more plant biomass was formed together with improved plant characteristics in the plants treated with PTSO EXTRACT. This indicates that the nutrient use efficiency was higher for the plants treated with PTSO EXTRACT. The observations made after the treatments on tomato plants in which PTSO EXTRACT was applied in the first 4 weeks of tomato crop cultivation, have shown that this was sufficient to induce a positive effect over the cultivation time of more than 6 months, which was very surprising. No deviations have been observed in terms of wilting, flower bud and/or flower fall, abnormal fruit, stalk or leaf shape or size.

Despite that all the treatments showed an improvement of crop quality parameters, it was found that only one administration method was effective in increasing the harvest, namely repeated treatments by dripping with a 25,000×diluted PTSO EXTRACT: this resulted in a cumulative tomato production increase of 8%

In this example it is clearly shown that the PTSO EXTRACT is a powerful biostimulant, in particular when it is administered more than once by the irrigation water.

TABLE 17
Cumulative tomato production in kilograms is
indicated at indicated day after planting.

| Day | 121 | 128 | 135 | 142 | 149 | 156 | 163 | 170 | 177 |
|---|---|---|---|---|---|---|---|---|---|
| Untreated | 1.1 | 2.2 | 4.0 | 5.8 | 7.0 | 7.5 | 9.8 | 10.7 | 11.5 |
| PE; 1:10000 spray | 0.9 | 1.8 | 3.8 | 5.5 | 7.1 | 8.0 | 9.9 | 11.0 | 11.3 |
| PE; 1:25000 spray | 0.9 | 2.1 | 4.2 | 5.9 | 7.0 | 7.8 | 10.2 | 10.9 | 11.4 |
| PE; 1:50000 spray | 1.1 | 2.1 | 4.0 | 5.6 | 7.2 | 7.9 | 10.0 | 10.7 | 11.2 |
| Serenade | 0.9 | 1.8 | 3.9 | 5.5 | 6.9 | 7.7 | 9.7 | 10.6 | 11.0 |
| PE; 1:10000 drip | 1.0 | 2.2 | 4.3 | 6.0 | 6.9 | 7.9 | 10.1 | 10.9 | 11.3 |
| PE; 1:25000 drip | 0.9 | 2.0 | 3.6 | 5.5 | 7.0 | 7.7 | 10.7 | 11.8 | 12.4 |
| PE; 1:50000 drip | 1.0 | 1.9 | 4.1 | 5.9 | 7.1 | 8.2 | 9.8 | 10.9 | 11.4 |

TABLE 18
Tomato head quality is indicated at indicated day after planting.

| Day | 124 | 131 | 142 | 152 |
|---|---|---|---|---|
| Untreated | 3.3 | 3.5 | 6 | 6.5 |
| PE; 1:10000 spray | 4.5 | 4.3 | 7.3 | 7 |
| PE; 1:25000 spray | 4.8 | 4.3 | 6 | 7 |
| PE; 1:50000 spray | 5 | 4 | 6.5 | 7 |
| Serenade | 4 | 4 | 7 | 7 |
| PE; 1:10000 drip | 4.5 | 4.3 | 7 | 7.3 |
| PE; 1:25000 drip | 3.5 | 4.8 | 7 | 7.5 |
| PE; 1:50000 drip | 4.8 | 3.3 | 7 | 7 |

TABLE 19
Rating of plant condition is indicated at day after planting.

| Day | 124 | 131 | 142 | 152 | 176 |
|---|---|---|---|---|---|
| Untreated | 5.8 | 6.3 | 6.3 | 6.8 | 5.3 |
| PE; 1:10000 spray | 6.8 | 6.8 | 7.8 | 7.3 | 7.5 |
| PE; 1:25000 spray | 7.5 | 7.5 | 7.8 | 7 | 7 |
| PE; 1:50000 spray | 7.5 | 7 | 6.8 | 6.8 | 6.5 |
| Serenade | 6.8 | 7.3 | 7.3 | 6.8 | 6.3 |
| PE; 1:10000 drip | 7 | 7.3 | 6.5 | 7.5 | 6.5 |
| PE; 1:25000 drip | 6 | 7.8 | 7.3 | 7.3 | 6.8 |
| PE; 1:50000 drip | 7.8 | 6 | 7.3 | 7.5 | 6.3 |

TABLE 20
Rating of plant colour is indicated at day after planting.

| Day | 124 | 131 | 142 | 152 | 176 |
|---|---|---|---|---|---|
| Untreated | 2.8 | 3.8 | 6 | 6.5 | 3.3 |
| PE; 1:10000 spray | 4.3 | 4 | 7.8 | 8 | 4.5 |
| PE; 1:25000 spray | 4.3 | 4.5 | 7.5 | 7 | 4.8 |
| PE; 1:50000 spray | 4.8 | 4.3 | 6.8 | 7.3 | 5 |
| Serenade | 4.3 | 4.3 | 6.8 | 7 | 4 |
| PE; 1:10000 drip | 4.8 | 4 | 7 | 7.3 | 5 |
| PE; 1:25000 drip | 3.3 | 4.5 | 7.3 | 7.3 | 3.8 |
| PE; 1:50000 drip | 4.8 | 3 | 6.8 | 7.8 | 3.3 |

### Example 5b. Treatment of Various Tomato Races

In this example the biostimulant effect of PTSO EXTRACT (PE) was demonstrated on various tomato races and with different growers.

Scope: tomato plants of various races were cultivated with different growers and were treated with PTSO Extract. In table 20a the tomato races and growers are summarised. The same tomato cultivation regime was used as described in example 5.

TABLE 20a
Applied tomato races, treatment data and the percentage cumulative
yield increase compared to untreated tomato plants of the same
race grown under the same conditions at the end of cultivation.

| | | Dose PTSO | | Number of | Tomato Yield |
|---|---|---|---|---|---|
| Grower | Tomato Race | EXTRACT* | | treatments | increase (%) |
| #1 | Mediax | 0.147 | l/ha* | 30** | 11 |
| #2 | Capricia | 0.147 | l/ha | 30 | 2 |
| #3 | Gerdicia | 0.147 | l/ha | 30 | 9.5 |

*Dilution depends on evaporation of the plants on that moment and varies from 7,000-35,000x;
**once per week

Conclusion: treatment with PTSO Extract clearly shows a yield increase with all tested tomato races and is broadly applicable.

### Example 6 Lettuce

Based on the results from above, an agricultural composition was prepared comprising 5.2% PTSO. The composition further comprises 59% emulsifier (propylene glycol and glyceryl polyethyleneglycol ricinoleate). The composition is referred to herein as “PTSO Composition 5.2”.

An orchard of open field lettuce variety Iceberg was selected. A randomised complete block design was done, with 4 replications per treatment. Six drip applications were conducted through drip irrigation system, with 120 kPa of 30 pressure and 10000 l/ha of water volume.
Treatment 1: UNTREATED CHECK+FARMER
PROGRAM+MATTER ORGANIC 10 L/ha
Treatment 2: 0.5 l/ha PTSO Composition 5.2+FARMER PROGRAM+MATTER ORGANIC 10 L/ha.
Treatment 3: 1 l/ha PTSO Composition 5.2+FARMER PROGRAM+MATTER ORGANIC 10 L/ha

In the examples described herein, “FARMER PROGRAM” refers to the standard growing conditions used by the farmers, such as for example, nutrients, standard crop protection, light regime, etc.

### Treatment

The treatments were applied six times approximately every two weeks with intervals from 14-24 days. The last treatment is referred to as treatment “F” and 10 DA-F referred to blow refers to the assessment carried out 10 days after the final treatment (treatment “F”).

The marketable yield (the number of lettuces per hectare, the kilograms of lettuces per hectare (kg/ha), weight per lettuce in grams and the percentage of marketable lettuces in the harvest) was assessed at 10 DA-F. In addition, the number of non-marketable lettuces per hectare and the percentage of non-marketable lettuces in the harvest, was carried out at 10 DA-F.

When treatment 1 is give the value 100%, the rest of the treatments showed higher values for marketable yield. Treatment 3 showed the highest value (102% on the number fruit per hectare, 121% on the kilograms per hectare, 118% on average grams per fruit and 102% on percentage of marketable lettuces in the harvest), followed treatment 2 (101% on the number fruit per hectare, 110% on the kilograms per hectare, 108% on average grams per fruit and 102% on percentage of marketable lettuces in the harvest).

When treatment 1 is give the value 100%, the rest of the treatments showed lower values for unmarketable yield. Treatment 3 showed the lowest value (61% on the number fruit per hectare and on percentage of unmarketable lettuces in the harvest) followed by treatment 2 (69% on the number fruit per hectare and on percentage of unmarketable lettuces in the harvest).

Laboratory tests were conducted on 8 lettuces per plot with similar development stage, one assessment was carried out at 10 DA-F, evaluating the aerial fresh weight (g), the root weight (g), the lettuce firmness (kg/cm2) and the fruit diameter (cm).

Regarding the fresh weight of the aerial part and the fresh weight of the root, when treatment 1 is give the value 100%, the rest of the treatments showed higher values. The highest fresh weight of the aerial part and the root was obtained by treatment 3 (117% and 123%, respectively), followed by Treatment 2 (107% and 101%, respectively).

Regarding the lettuce diameter, when treatment 1 is give the value 100%, treatment 3 had a value of 107% and treatment 2 a value of 104%.

Regarding the lettuce firmness, when treatment 1 is give the value 100%, treatment 3 had a value of 133% and treatment 2 a value of 125%.

Finally, 5 lettuces per plot with a similar stage of development were taken from each harvest and weighed, placed in a cold room at 6° C. and the weight loss per lettuce was evaluated over the following 13 days; 92 DAP (Days After Plant), 93 DAP, 94 DAP, 95 DAP, 96 DAP, 97 DAP, 98 DAP, 99 DAP, 100 DAP, 101 DAP, 102 DAP, 103 DAP and 104 DAP, calculating the percentage of weight lost per lettuce over the whole period of conservation. Then, the same lettuces were left at room temperature (14° C.) and the weight loss per lettuce was re-evaluated in the following 7 days; 105 DAP, 106 DAP, 107 DAP, 108 DAP, 1109 DAP, 110 DA and 111 DAP, calculating at the end the percentage of weight lost per lettuce in the whole period.

### Example 7 Cucumber

An orchard of cucumber variety Katrina was selected. Elemental plots were 18 m2, with 13 plants per plot. Fourteen drip applications (applications ABCDEFGHIJKLMN) for PTSO Composition 5.2 and seven applications (ACEGIKM) for Isabion™, were conducted using a drip irrigation system, with 10000 l/ha of water volume and with 120 kPa of pressure. The applications were carried out with an interval of 7 days for PTSO Composition 5.2 and 14 days for Isabion™
Treatment 1: UNTREATED CHECK
Treatment 2: Farmer check
Treatment 3:0.4 l/ha PTSO Composition 5.2+Isabion 4 L/ha+41 g free amino acids, 40 g nitrogen, 118 g organic carbon
Treatment 4: 0.4 l/ha PTSO Composition 5.2

The marketable yield (the kilograms of fruits per hectare (kg/ha), the number of fruits per hectare and fruit weight (g), was assessed at 3 DA-B (i.e., 3 days after treatment B), 6 DA-B, 3 DA-C, 6 DA-C, 3 DA-D, 6 DA-D, 3 DA-E, 7 DA-E, 4 DA-F, 1 DA-G, 5 DA-G, 3 DA-H, 6 DA-H, 3 DA-I, 7 DA-I, 5 DA-J, 3 DA-K, 7 DA-K, 4 DA-L, 1 DA-M, 5 DA-M and 3 DA-N calculating at the end, the total yield and average. The diameter and length of fruit (mm) was assessment at 3 DA-E and 7 DA-K.

Regarding the marketable yield (kg of fruits per hectare and number of fruits per hectare), when treatment 1 is give the value 100%, treatment 3 obtained the highest yield (116% on kg/ha and 113% on number of fruits), followed by treatment 4 (112% on kg/ha and 110% on number of fruits) and treatment 2 (104% on kg/ha and 104% on number of fruits).

Regarding the diameter of fruit, when treatment 1 is give the value 100%, treatment 3 resulted in 103-104%, treatment 4 resulted in 102-104% and treatment 1 in 102-103%.

Regarding the length of fruit, when treatment 1 is give the value 100%, treatment 3 resulted in 106-107%, treatment 4 resulted in 106% and treatment 1 in 103-105%.

### Example 8 Treatment of Cloned Cymbidium Plants

Cutflower producing Cymbidium growers usually have to grow their own plants before flower production can take place. In order to obtain flowers that are as uniform as possible, they have to pregrow their plants from clones (meristems): it may take 5 years or more before the production of flowers is on the economically desired level.

Growth and development of plants encompasses three stages: (1) vegetative growth during which a pseudobulbs are formed at the end of shoot formation, (2) flower induction, and (3) development of flower stalks. It is economically interesting to keep the grow-up time as short as possible to grow up the plants to flowering size. In this experimental design a PTSO extract (at least 56% emulsified PTSO(PE)) is used to demonstrate the biostimulatory effect of PTSO on young Cymbidiums plants.

For this purpose, young meristem plants of the orchid Cymbidium “49er” were selected. The plants had still to develop the first pseudobulb after transplanting from the flask. After the treatments as mentioned below, the plants were evaluated as indicated below after 206 days.

### Experimental Design

### Plant Cultivation Procedure

Plants of Cymbidium “49er” were produced from meristems. Upon delivery at the Cymbidium grower, the plants were potted into black 9 cm pots in middle-sized coco peat to which Osmocote fertilisation granules were added (1.25 kg/, M³). The plants were fed twice a day with 40 ml fertilised feed (EC 0.4) via an automatic watering system via an infusion system. The plants adapted to the green house conditions and the treatment with PTSO EXTRACT began approximately 4 months after re-potting.

In the example, 25 plants were used per treatment. The distance between the plants were about 15 cm. The plants were monitored on growth of leaves by measuring the length and largest wideness of the largest leaf, on pseudobulb formation, final size and appearance and number of new shoots. The number of roots and green root tips were monitored by visual inspection. Furthermore, an overall judgment was done on the plants with respect to appearance and healthiness. Per treatment, 8 to 24 plants were judged.

The dilutions of PTSO extract, the frequency and intervening time between recurring treatments is indicated in table 21. The plants were manually administered with 40 ml of the indicated dilution PTSO extract. The control was watered with 40 ml the standard fertilised plant feed as indicated above. After the treatments, the treated plants undergo the same cultivation procedure as the control plants, i.e. the untreated plants.

TABLE 21
Summary of the applied treatments during the experiment.

| Treatment | Dilution rate PTSO | Number of | |
|---|---|---|---|
| number | extract | treatments | Intervening time |
| 1 = control | n.a. | none | — |
| 2 | 1000x | 1 | n.a.- |
| 3 | 1000x | 2 | 1 week |
| 4 | 1000x | 3 | 1 week |
| 5 | 1000x | 4 | 1 week |
| 6 | 2500x | 1 | n.a. |
| 7 | 2500x | 2 | 1 week |
| 8 | 2500x | 3 | 1 week |
| 9 | 2500x | 4 | 1 week |
| 10 | 1000x | 10 | 2 weeks |
| 11 | 2500x | 10 | 2 weeks |

n.a.: not applicable

The plants were scored on the indicated variables at t=0, t=112 days and t=206 days.

The height and thickness of the pseudobulb, the length and wideness were measured by the use of a tape-line. The quantity of roots and the fresh white growing root tips were estimated on a scale of 1-10.

The quantity of roots were judged after comparison of the roots of a plant with a plant with an average root formation of the control group. For this purpose, the plants were taken out of the pot and compared to a standard plant that is judged as “average” of the control treatment.

The number of fresh root tips were judged as follows. 1: 0-20% of the roots showed white growing root tips; 2: 20-40% of the roots showed white, growing root tips; 3: 40-60% of the roots showed fresh growing root tips; 4, 60-80% of the roots had growing, white root tips; 5: 80-100% of the roots showed growing white root tips. The “Appearance of new shoots” is calculated as the number of new shoots dived by the total number of judged plants of the treatment.

The “Robustness” of the plants was an arbitrary judgment that was given after a plant was compared to an average plant of the control group and varied from 1-10: 1 is the lowest score and a 10 is the highest score.

### Results

In the tables 22-24 the results are presented of the averages of the treatments.

TABLE 22
Average of quality variables of Cymbidium 49er plants at t = 0.

| | Treatment | | | | | | | | | | |
|---|---|---|---|---|---|---|---|---|---|---|---|
| Rating variable | 1 | 2 | 3 | 4 | 5 | 6 | 7 | 8 | 9 | 10 | 11 |
| Number of leaves | 12.1 | 12.1 | 11.8 | 11.6 | 12.8 | 12.4 | 12.5 | 12.6 | 11.9 | 11.6 | 12.0 |
| Height pseudobulb (cm) | 0 | 0 | 0 | 0 | 0 | 0 | 0 | 0 | 0 | 1 | 0.75 |
| Thickness pseudobulb (cm) | 0 | 0 | 0 | 0 | 0 | 0 | 0 | 0 | 0 | 0.44 | 0.44 |
| Length longest leave (cm) | 49.5 | dev | dev | dev | dev | dev | dev | dev | dev | dev | dev |
| Largest wideness of longest leaf (mm) | 20.0 | dev | 20.1 | 19.6 | 20.5 | 20.0 | 18.0 | 19.0 | 19.9 | 19.0 | 19.8 |
| Appearance of new shoots | 0 | 0 | 0 | 0 | 0.36 | 0 | 0.13 | 0.13 | 0 | 0.13 | 0.13 |
| Quantitity of roots | 3 | 3 | 3 | 3 | 3 | 3 | 3 | 3 | 3 | 3 | 3 |
| Growing root tips | 3 | 3 | 3 | 3 | 3 | 3 | 3 | 3 | 3 | 3 | 3 |
| Robustness plant | 4.0 | 3.9 | 4.0 | 3.5 | 4.5 | 4.3 | 4.1 | 4.8 | 4.1 | 4.4 | 4.1 |
| Ranking | 9 | 10 | 8 | 11 | 2 | 1 | 6 | 1 | 7 | 3 | 5 |

dev: the leave was still growing and it was not possible to perform an objective measurement yet

TABLE 23
Average per treatment of the quality variables of Cymbidium 49er plants at t = 112 days.

| | Treatment | | | | | | | | | | |
|---|---|---|---|---|---|---|---|---|---|---|---|
| Rating variable | 1 | 2 | 3 | 4 | 5 | 6 | 7 | 8 | 9 | 10 | 11 |
| Number of leaves adult shoot/ | 9.6/1.8 | 10.1/2.5 | 9.8/3.2 | 9.8/1.5 | 11/1.9 | 10.8/2.4 | 9.5/2.9 | 8.9/2.8 | 10.4/1.5 | 9.6/2.6 | 9.1/2.7 |
| Number of leaves new shoot | | | | | | | | | | | |
| Height pseudobulb (cm) | 5.0 | 4.9 | 5.7 | 4.7 | 5.1 | 5.0 | 5.6 | 5.4 | 3.8 | 4.6 | 5.0 |
| Thickness pseudobulb (cm) | 3.1 | 3.3 | 3.6 | 3.1 | 3.2 | 3.6 | 3.5 | 3.1 | 2.8 | 3.1 | 3.5 |
| Length longest leave (cm) | 13.4 | 15.4 | 17.8 | 11.2 | 8.8 | 18 | 20.7 | 28 | 9.9 | 17.6 | 22.9 |
| Largest wideness of longest leaf | 20 | N.D. | 20.1 | 19.6 | 20.5 | 20 | 17.8 | 19 | 19.9 | 19 | 19.8 |
| (mm) | | | | | | | | | | | |
| Appearance of new shoots | 1.8 | 2.5 | 3.2 | 1.5 | 1.9 | 2.4 | 2.9 | 2.8 | 1.5 | 2.6 | 2.7 |
| Quantity of roots | 3.8 | 4.5 | 5.2 | 3.9 | 4.7 | 5.5 | 4.6 | 4.9 | 4.2 | 4.3 | 5.9 |
| Growing root tips | 4 | 1 | 4 | 4 | 5 | 4 | 2 | 2 | 3 | 4 | 4 |
| Robustness plant | 3.8 | 4.5 | 4.2 | 4.5 | 4.4 | 5.3 | 5.9 | 6.1 | 5.0 | 5.2 | 6.3 |
| Ranking | 11 | 7 | 10 | 8 | 9 | 4 | 3 | 2 | 6 | 5 | 1 |

N.D.: not determined

TABLE 24
Average per treatment of the quality variables of Cymbidium 49er plants at t = 206 days.

| | Treatment | | | | | | | | | | |
|---|---|---|---|---|---|---|---|---|---|---|---|
| Rating variable | 1 | 2 | 3 | 4 | 5 | 6 | 7 | 8 | 9 | 10 | 11 |
| Number of leaves adult shoot/ | 9.6/5.2 | 10.1/5.1 | 9.8/5.1 | 9.8/4.3 | 11/5.2 | 10.8/4.3 | 9.5/5.3 | 8.9/6.2 | 10.4/4.7 | 9.6/5.2 | 9.1/5.8 |
| Number of leaves new shoot | | | | | | | | | | | |
| Height pseudobulb (cm) | 5.0 | 4.9 | 4.7 | 4.7 | 5.1 | 5.0 | 5.6 | 5.4 | 3.8 | 4.6 | 5.6 |
| Thickness pseudobulb (cm) | 3.1 | 3.3 | 3.1 | 3.1 | 3.2 | 3.6 | 3.5 | 3.1 | 2.8 | 3.1 | 3.6 |
| Length longest leave (cm) | 38.5 | 36.7 | 40.9 | 33.5 | 34.8 | 33.5 | 39.5 | 36.0 | 28.8 | 37.9 | 42.3 |
| Largest wideness of longest leaf (mm) | 24.3 | 23.2 | 26.6 | 24.7 | 24.7 | 24.7 | 22.8 | 25.3 | 24.5 | 26.5 | 24.1 |
| Appearance of new shoots | 1.1 | 1.1 | 1.1 | 1.1 | 1.1 | 1.0 | 1.1 | 1.2 | 1.00 | 1.1 | 1.1 |
| Quantity of roots | 4 | 5 | 5 | 4 | 4 | 4 | 5 | 5 | 5 | 5 | 5 |
| Growing root tips | 4 | 5 | 4 | 4 | 3 | 4 | 5 | 5 | 5 | 5 | 5 |
| Robustness plant | 4.0 | 4.1 | 4.2 | 3.8 | 4.2 | 3.8 | 4.7 | 4.6 | 5.0 | 4.8 | 6.2 |
| Ranking | 9 | 8 | 6 | 11 | 7 | 10 | 4 | 5 | 2 | 3 | 1 |

N.D.: not determined

During the experiments, all plants developed well and no negative effects on the plants were detected by the PTSO-extract. A ranking was made for the plants at t=0 (Table 2), but strictly speaking, the differences between the plants were extremely small. This is usual for plants that are grown from meristems and cultivated under the same conditions for 4 months prior to the start of the experiment. Hereafter the plants were treated according to the schedule as is presented in Table 21.

After 112 days the plants of treatment 11 were significantly larger and more robust (Table 23.). A well-developed robust plant with a high score is a plant with relative large pseudobulbs (for the storage of reserve carbohydrates), large leaf-surface (for photosynthesis, a fast-growing large new shoot and a well-developed root system for the uptake of water and minerals. Repeated dosing of PTSO EXTRACT resulted in more positive effects (see, e.g., treatments 7-11).

### Example 9 Effect of Organosulfur Compounds on Lettuce and Sweet Peppers

Experimental design. The bio-stimulatory effects of organosulfur compounds was tested on lettuce and sweet pepper (Capsicum annuum “Ritmico”). The tested compounds include di-n-propyl disulfide (GAS 629-19-6), di-n-propyl thiosulfonate (i.e., PTSO, CAS 1113-13-9), di-methyl thiosulfonate (GAS 2949-92-0), and di-phenyl thiosulfonate (Gas 1212-08-4). Di-methyl thiosulfonate and di-phenyl thiosulfonate were ordered from Adrich-Sigma. PTSO was purified as described in example 1. In order to obtain a stable and homogenous emulsion, the compounds were dissolved into an emulsifier solution (table 25) to assure that the crops are supplied with the defined solution. In this way it is prevented that precipitations or immiscibility occurred of the organosulfur compounds. As examples herein, “PTSO Composition 5.2” refers to an agricultural composition comprising 5.2% PTSO and further comprises 59% emulsifier (propylene glycol and glyceryl polyethyleneglycol ricinoleate). “PTSO composition 5.2 Yuka” in an agricultural composition comprising 5.2% PTSO and 90.2% Yuka extract. “PTSO composition 5.2 Tween” in an agricultural composition comprising 5.2% PTSO, 30.1% Tween, 30.1% DMSO and 30% water. The controls and treatments are indicated in table 27.

The dosage of the test compounds was standardized on base of the molar dosage and the same molar dosage was administered as PTSO. Emulsions were prepared by adding the required amount of the compounds as indicated in table 25 in 100 ml volumes of 50% tween 80 and 50 ml DMSO. Hereafter, the volumes were supplemented to a final volume of 250 ml with the same mixture and incubation took place at an orbital shaker at 37° C. (30 minutes, 250 rpm).

TABLE 25
Stock solutions of the indicated products and organosulfur
compounds that are used for the biostimulant tests.

| | | Final | |
|---|---|---|---|
| | | concentration | Percentage |
| | | organosulfur | in stock |
| | | compound in | solution |
| Compound/Product | Description | stock (M) | (v/v) |
| Control | Tween-DMSO | | |
| PTSO Composition 5.2 | PTSO-extract | 0.4 | 7 |
| Pure PTSO (>98% | Pure PTSO in Tween-DMSO | 0.4 | 7 |
| purity) | | | |
| Di-n-propyl disulfide | Pure DPDS in Tween-DMSO | 0.4 | 6 |
| (99%) | | | |
| Di-methyl | Dimethyl thiosulfonate in | 0.4 | 5 |
| thiosulfonate (97%) | Tween-DMSO | | |
| Di-phenyl | Di-phenyl thiosulfonate in | 0.4 | 10 |
| thiosulfonate (99%) | Tween-DMSO | | |
| PTSO composition 5.2 | Croptimum BIO (89% | 0.4 | 10 |
| Yuka | Yucca + PTSO-extract) | | |
| PTSO composition 5.2 | PTSO-extract in Tween- | 0.4 | 7 |
| Tween | DMSO | | |

Before seeding, the seeds of lettuce were drenched into 1000× diluted emulsions as indicated in table 25 and incubated for 10 minutes. Each treatment was performed in 4-fold. In table 26 the growth settings of lettuce and sweet peppers are summarized and in table 27 a summary of the realized growth conditions and crop harvest is presented of lettuce.

As demonstrated at Table 27, all treatments of lettuce showed an increase in relative fresh weight/plant compared to control and increased harvest weight per plant compared to control. At the time of measuring the growth of peppers, no fruits were yet present. However, preliminary results indicate that all treatments led to an increase in crop vigor as measured by the relative size compared to control.

TABLE 26
Cultivation conditions, settings and treatment of lettuce and sweet pepper.

| | Cultivation conditions | | | | | |
|---|---|---|---|---|---|---|
| | Number of plants | | | | | Treatment |
| | or crop area/ | | | Settings | | Start |
| Crop/race | treatment | Root substrate | Plant feed* | Temperature | Plant feed | treatment |
| Sweet | 80 | Soil, sandy | drip | Fixed | Drip | 7 weeks |
| pepper | | loam | | aeration, max | | after |
| (Capsicum | | | | 40° C. | | planting |
| annuum) | | | | | | |
| “Ritmico” | | | | | | |
| Lettuce | 180 | Standard | Manual | 21° C. | n.a. | During |
| Lactuca | | potting soil | watering | | | seeding |
| sativa | | | | | | |
| “volare” | | | | | | |

| | Treatment | | | | Finish |
|---|---|---|---|---|---|
| | | Total amount | | | Last evaluation |
| | | product per | Number of | | of experiment |
| | | treatment | treatments/ | | after . . . days |
| Crop/race | Dilution | (litres/ha) | frequency | replications | (after planting) |
| Sweet | 17,000 | 0.6 | 5; once | 4 | 91 |
| pepper | | | per 7 | | |
| (Capsicum | | | days | | |
| annuum) | | | | | |
| “Ritmico” | | | | | |
| Lettuce | 1,000 | n.a. | 1 | 4 | 17 days |
| Lactuca | | | | | after |
| sativa | | | | | seeding |
| “volare” | | | | | |

TABLE 27
Assessed growth growth parameters during the experiment and crop characteristics/harvest growth

| | | | | | | Crop parameters |
|---|---|---|---|---|---|---|
| | | Variability actual growth conditions | | | | Harvest |
| | | | Relative | Plant | | Fresh |
| | | Temperature | humidity | feed | Light | weight/ |
| Crop | Treatment | (° C.) | (%) | supply | supply | plant |
| Lettuce | Emulsifier solution | 21 | 70-95 | Kept | 25 Watt | 1.63 |
| Lactuca sativa | (Control) | | | moist | LED-tubes | |
| “volare” | PTSO Composition 5.2 | | | | at 30 cm | 1.93 |
| | Di-propyl disulfide | | | | above plants. | 1.80 |
| | Di-n-propyl thiosulfonate | | | | After | 1.84 |
| | di-methyl thiosulfonate | | | | germination | 1.96 |
| | Di-phenyl thiosulfonate | | | | lid of seed | 1.68 |
| | PTSO composition 5.2 Yuka | | | | box was | 2.21 |
| | PTSO composition 5.2 | | | | removed | 1.74 |
| | Tween | | | | | |
| Capsicum | Emulsifier solution | 18-35 | 90-20 | Drip | Sunny | Not yet |
| annuum | (Control) | | | | | |
| “Ritmico” | PTSO Composition 5.2 | | | | | |
| | Di-propyl disulfide | | | | | |
| | Di-n-propyl thiosulfonate | | | | | |
| | di-methyl thiosulfonate | | | | | |
| | Di-phenyl thiosulfonate | | | | | |
| | PTSO composition 5.2 | | | | | |
| | Yuka | | | | | |
| | PTSO composition 5.2 | | | | | |
| | Tween | | | | | |

| | | Crop parameters | | | |
|---|---|---|---|---|---|
| | | Relative | Root | Added harvest | Relative |
| | | fresh | formation | (weight) per | size |
| | | weight/plant | (%) | plant | compared |
| | | compared to | compared | compared to | to control |
| Crop | Treatment | control (%) | to control | control (%) | (%) |
| Lettuce | Emulsifier solution | 100 | 100 | | ND |
| Lactuca sativa | (Control) | | | | |
| “volare” | PTSO Composition 5.2 | 118 | 114 | 18 | |
| | Di-propyl disulfide | 110 | 109 | 10 | |
| | Di-n-propyl thiosulfonate | 113 | 110 | 13 | |
| | di-methyl thiosulfonate | 120 | 115 | 20 | |
| | Di-phenyl thiosulfonate | 103 | 93.9 | 3 | |
| | PTSO composition 5.2 Yuka | 136 | 130 | 36 | |
| | PTSO composition 5.2 | 107 | 96.8 | 7 | |
| | Tween | | | | |
| Capsicum | Emulsifier solution | ND | ND | n.a. | |
| annuum | (Control) | | | | |
| “Ritmico” | PTSO Composition 5.2 | | | | 2.2 |
| | Di-propyl disulfide | | | | 2.8 |
| | Di-n-propyl thiosulfonate | | | | 4.2 |
| | di-methyl thiosulfonate | | | | 6.1 |
| | Di-phenyl thiosulfonate | | | | 2.8 |
| | PTSO composition 5.2 | | | | 0.6 |
| | Yuka | | | | |
| | PTSO composition 5.2 | | | | 2.4 |
| | Tween | | | | |

ND: Not determined;
n.a.: not applicable

### Example 10 Analysis of PTSO in Onion and Garlic Oil

Scope: onion and garlic oil and onion and garlic extracts were obtained as described in Hemat S. Abd El-Salam et al. (2014)(I Enhancement of Cumin (Cuminum cyminum L.) Productivity Using Some Natural Plant Extracts. Egypt. J. Hort. Vol. 41, No. 2, p 209-219. The samples were analysed for the presence of PTSO as follows.

Experimental design: The presence of PTSO (di-n-propyl thiosulfonate) was detected by LC-MS/MS. Standards of PTSO (GAS 1113-13-9) were obtained by organic synthesis from Symeres (Mercachem Holding B.V.). The identity of the compound was confirmed by ¹H-NMR and LC-MS and the purity was determined by LC-UV and was determined to be >99.1%.

This sample was used to prepare equilibration graphs. For spiking and equilibration, samples were prepared containing pure PTSO from 2 to 200 μM in HPLC-grade methanol.

The LC-MS/MS (API4000, Sciex) had the following configuration: synchronization mode setting is LC-Sync, as pre-column the Vanguard BEH C18 2.1×5 mm and as HPLC column the Acquity BEH C18 2.1×50 mm 1.7 μm were used. The injector was supplied by Nexera.

The oven was set at 40° C. The pumping mode was ternary flow. The pump settings were the following: total flow was 0.4 ml/min; pump B concentration (%) is 0.0, pump C concentration (%) is 50.0. The pump B and pump C curves were 0, the minimum pressure and maximum pressure limits were 0 and 16,000 psi, respectively. Pump A was used for solution LC-A (0.05% FA (Formic Acid) in 5% methanol in UPW (Ultrapure water)). Pump C was used to pump methanol.

### Settings MS:

TABLE 28
General

| | |
|---|---|
| Ion source | TIS probe |
| Ion source offset (mm) | Height 0.0/Centre 5.0 |

Period 1

| | |
|---|---|
| Acquisition time (min) | 2.0 |
| Scan type | Positive MRM |
| Q1 resolution | Unit |
| Q3 resolution | Unit |

TABLE 29
MS source settings

| MS source | MS setting |
|---|---|
| CUR (Curtain gas) (psi) | 40 |
| CAD (Collision gas) | 6 |
| GS1 (Nebulizer gas) (psi) | 60 |
| GS2 Turbo Gas | 70 |
| IS (Ion spray) (V) | 5500 |
| TEM (Temperature)(° C.) | 350 |
| Ihe (Interface heater) | on |

Method: calibration standards in the range from 2.00 to 200 μM (PTSO) were freshly prepared in MeOH.

Isolation of PTSO from the samples was performed by extraction into organic solvent (methanol (MeOH), ethyl acetate (EtOAc), n-butanol and dichloromethane (DCM)). The ratio between sample and extraction solution is maximal 1 or smaller. Preparative research showed that the extraction efficiency of the sample is between 30 and 40% and therefore, reference samples must be included in the procedure. Sample volumes of 20 μl were injected by the autosampler.

The extracts were analyzed using an API 4000 LC-MS/MS system (PTSO).

Data acquisition was performed using Analyst software (version 1.6.3) from AB Sciex. Following peak area integration, regression was also performed using Analyst. Concentrations were calculated using weighted linear regression, according to the following formula: y=a+bx (weighting factor=1/x2) where: x=PTSO concentration in μM y=Peak-area ratio a=Intercept b=Slope.

The calibration range for PTSO is 2.0-200 μM, the quantitative assay range >2,0 μM, the qualitative assay range is >1.0 μM, both with a sample volume of 20 μl.

### Results:

TABLE 30

| Sample | Detected PTSO (mg/l) |
|---|---|
| Onion oil | <0.2 |
| Garlic oil | <0.2 |
| Onion Extract | <0.2 |
| Garlic Extract | <0.2 |

From these results it is demonstrated that no PTSO was detectable in onion and garlic derived from the respective oils and extracts.

### Example 11 Effects on Other Crops

Scope: The effects of the PTSO extract were tested on various other crops. The tables describe the results from crops where a visible effect in at least one measured variable was observed.

Study design: Table 32 summarizes the crops tested with the corresponding growth conditions and treatments. The crops were precultivated with plant growers and planted in plastic greenhouses with constant aeration (day and night) or in the open fields. The plants were fed via plugs or irrigation water. All the nutrients in the plant feed were supplied in excess. Dependent on the crops, fruits were harvested at regular time intervals and the cumulative weight of the fruits was determined. The PTSO Extract was supplied via the roots via the plant feed. With a limited number of crops, root formation and chlorophyll content were also measured.

In table 32 the growth variables that were monitored and the harvests are presented. The growth parameters temperature, relative humidity and light supply vary considerably because these parameters were not controlled and dependent of the weather conditions that change during the day. Weather conditions are changing with the seasons and so the month that the experiments were started is indicated in the table. In June the light intensity is highest and the variability of the day-night temperature, the corresponding relative humidity and evaporation are largest. These (extreme) variabilities result in high abiotic stress. Since it is assumed that PTSO Extract reduces the sensibility of the plants for abiotic stress, it was expected that the larger the changes of the abiotic stress factors is, the more pronounced the positive effects of the treatment are on the crops.

Table 33 demonstrates that PTSO Extract did not show any negative effects on crop properties like damaged leaves, crop colour, deformed leaves or size, stalks, fruit shape and flowers and did not affect root formation negatively. Crop condition was unchanged or better.

The growth conditions were kept the same for PTSO Extract-treated and untreated plants (controls). This implies that the nutrient use efficiency was higher for PTSO Extract-treated plants and this makes PTSO a biostimulant.

Since the greenhouse aeration was constant during the day and not controlled as a function of temperature, high temperature and humidity deviations are expected dependent on the wind and sun. The relative air humidity varies inversely proportional with temperature, so large deviations are also expected. Irrigation water supply may also become limiting during hot periods and this results in the uptake of too little water uptake and loose of cell-turgor, resulting in hanging leaves and closing of the stomata. On that moment photosynthesis stops. These uncontrolled environmental factors result in a lot of abiotic stress, and while not wishing to be bound by theory, it is suggested that PTSO Extract diminishes the effect of abiotic stress on plants, resulting in a higher level of photosynthesis-related metabolites, healthier crops and higher crop yields. Dependent on the crop, additional positive properties were observed, as an improved root system and a higher level of chlorophyll (table 33). Significant faster growth and improved crop properties were obtained with other crops (rose, thicker and/or longer stalks and shiny leaves; melons, greener and bigger leaves; string beans, a significant larger crop; tomatoes, a larger head and more chlorophyll).

Table 31 provides a summary of improved crop characteristics after treatment with PTSO Extract. Not all possible crop characteristics were monitored, so other characteristics were likely also improved but were not measured in the present experiment.

TABLE 31

| Crop | Improved crop characteristic |
|---|---|
| Phalaenopsis | More roots, bigger plants, more shine on |
| | leaves |
| Cymbidium | Bigger Pseudobulbs and shape |
| Chrysanthenum | More roots, bigger plants |
| Sweet pepper (Capsicum annuum) | More harvest (total fruit weight and fruit |
| | numbers), higher content chlorophyl |
| Zucchini (Cucurbita pepo giromontiina) | More fruits and higher total fruit weight |
| Tomato (Solanum lycopersicum) | More fruits, higher total fruit weight, higher |
| | fruit diameter, more BRIX, better taste |
| Cucumber (Cucumus sativus) | More fruits and higher total fruit weight |
| Green beans (Phaseolus vulgaris) | Higher fruit weight, more roots |
| String beans (Phaseolus vulgaris) | Higher fruit weight, more roots |
| Tender Stem Broccoli (Brassica | More harvested weight |
| oleracea var. italica) | |
| Bok Choi (Brassica rapa chinensis) | More harvested weight |
| Garden peas (Pisum sativum) | More harvested fruit weight |
| Rose (Rosa) | Faster growth and development, thicker |
| | stalks, more shiny leaves, more marketable |
| | flowers. |
| Grapes (Vitis vinifera) | More harvested weight |
| Blueberries (Vaccinia corymbosum) | More harvested weight |
| Cucumus melo | More harvested fruit |

TABLE 32
Cultivation conditions, settings and treatment of various crops. The relative humidity was not
controlled in greenhouses and no artificial lightning took place. The plant feed is administered
manually or automatic. With respect to climate control no settings were used to control temperature,
ventilation is arranged in that way that no overheating occurs of the plants.

| | Cultivation conditions | | | Settings | | |
|---|---|---|---|---|---|---|
| | Number of | Location and | | Date or Month | | |
| | plants area/ | spacing | Root | experiment | T | Plant |
| Crop/race | tmnt* | plants | substrate | has started | (° C.) | feed |
| Sweet pepper | 200 | In greenhouse | soil, sandy | 10 Aug | Fixed | Drip |
| (Capsicum | | Row space:0.5 m | loam | | aeration, | |
| annuum) | | Row width:2.0 m | | | max | |
| “Martinica” | | 20.000 | | | 40° C. | |
| | | plants/ha | | | | |
| Sweet pepper | 51 | In greenhouse | soil, sandy | 6 Sep | Fixed | Drip |
| (Capsicum | | Row | loam | | aeration, | |
| annuum) | | space:0.35 m | | | max | |
| “Palermo” | | Row width:2.0 m | | | 40° C. | |
| | | 28.600 | | | | |
| | | plants/ha | | | | |
| Zucchini | 40 | In greenhouse | soil, sandy | 10 Nov | Fixed | Drip |
| (Cucurbita | | Row space:0.4 m | loam | | aeration, | |
| pepo | | Row width:2.0 m | | | max | |
| giromontiina) | | | | | 40° C. | |
| “Sinatra” | | | | | | |
| Tomato | 48 | In greenhouse | soil, sandy | 7 Nov | Fixed | Drip |
| (Solanum | | Row space:0.5 m | loam | | aeration, | |
| lycopersicum) | | Row width:2.0 m | | | max | |
| “arrebol” | | | | | 40° C. | |
| Cucumus | 13 | In greenhouse | sandy clay | 26 Nov | Fixed | Drip |
| sativus | | Row space:0.7 m | loam | | aeration, | |
| “Katrina” | | Row width:2.0 m | | | max | |
| Cucumber | | | | | 40° C. | |
| Green beans | 62,500 (0.5 | In the fields | loam | 13 Jan | Free | n.a. |
| Phaseolus | ha) | Row space:0.2 m | | | | |
| vulgaris | | Row width:0.4 m | | | | |
| “. . .” | | | | | | |
| sperziebonen | | | | | | |
| String beans | 62,500 (0.5 | In the fields | loam | 13 Jan | Free | n.a. |
| Phaseolus | ha) | Row space:0.2 m | | | | |
| vulgaris | | Row width:0.4 m | | | | |
| “. . .” | | | | | | |
| (Snijbonen) | | | | | | |
| Tender Stem | 62,500 (0.5 | In the fields | loam | 13 Jan | Free | n.a. |
| Broccoli | ha) | Row space:0.2 m | | | | |
| (Brassica | | Row width:0.4 m | | | | |
| oleraceae | | | | | | |
| var. italica) | | | | | | |
| “. . .” | | | | | | |
| Bok Choi | 48 | In greenhouse | clay | 15 Sep | Free | n.a. |
| (Brassica rapa | | Row space: 0.2 m | | | | |
| chinensis) | | Row width: 0.6 m | | | | |
| “Joi choi” | | | | | | |
| Garden peas | 62,500 (0.5 | In the fields | loam | 13 Jan | Free | n.a. |
| (Pisum | ha) | Row space:0.2 m | | | | |
| sativum) | | Row width:0.4 m | | | | |
| “. . .” | | | | | | |
| (Tuinerwten) | | | | | | |
| Rose (Rosa) | 40,000 (0.5 | In greenhouse | loam | December | Free | Irrigation |
| “Athena” | ha) | Row space: 0.25 m | | | | water |
| | | Row width: 0.50 m | | | | |
| Grapes (Vitis | 39 | In the fields | loam | 1 Jun | Free | Irrigation |
| vinifera) | | Row space: 1.25 m | | | | water |
| “Tempranello” | | Row width: 1.75 m | | | | |
| Blueberries | 320 | In the Fields | sandy | March | Free | Irrigation |
| (Vaccinia | | Row space: 0.9 m | | | | water |
| corymbosum) | | Row width: 3 m | | | | |
| “Ventura” | | | | | | |
| Melon | 13,300 (1 | In the Fields | Sandy loam | 23 Jun | Free | Irrigation |
| (Cucumus | ha) | Row space: 0.5 | | | | water |
| melo) “Piel de | | Row width: 1.5 m | | | | |
| Sapo” | | | | | | |

| | Treatment | | | | | Finish |
|---|---|---|---|---|---|---|
| | | | Dose PTSO | | | Stop experiment |
| | | | Extract | Number of | Repeats | after . . . |
| | Start | | per tmnt | tmnts/ | per tmnt | weeks after |
| Crop/race | tmnt | Dilution | (litres/ha) | frequency | (=n) | start experiment |
| Sweet pepper | 22 weeks | 14,000 | 0.7 | 9; once per 9 | 4 | 21 |
| (Capsicum | after | | | days | | |
| annuum) | planting | | | | | |
| “Martinica” | | | | | | |
| Sweet pepper | 8 weeks | 14,000 | 0.7 | 19, once per | 4 | 28 |
| (Capsicum | after | | | 7-8 days. | | |
| annuum) | planting | | | Isabion: 10, | | |
| “Palermo” | | | | once per 14 | | |
| | | | | days | | |
| Zucchini | 3 weeks | 33,300 | 0.3 | 20; once a | 3 | 24 |
| (Cucurbita | after | | | week | | |
| pepo | planting | | | Isabion: 10, | | |
| giromontiina) | | | | once per 14 | | |
| “Sinatra” | | | | day | | |
| Tomato | 9 weeks | 17,000 | 0.6 | 12; once per | 4 | 21 |
| (Solanum | after | | | 10 days | | |
| lycopersicum) | planting | | | Isabion: 10, | | |
| “arrebol” | | | | once per 14 | | |
| | | | | days | | |
| Cucumus | Directly | 25,000 | 0.4 | 14; every | 4 | 13 |
| sativus | after | | | week | | |
| “Katrina” | planting | | | | | |
| Cucumber | | | | | | |
| Green beans | 7 February | 40,000 | 1.25 | 11; once | 1 | 18 |
| Phaseolus | (same year) | | | per week | | |
| vulgaris | | | | | | |
| “. . .” | | | | | | |
| sperziebonen | | | | | | |
| String beans | 7 February | 40,000 | 1.25 | 11; once | 1 | 18 |
| Phaseolus | (same year) | | | per week | | |
| vulgaris | | | | | | |
| “. . .” | | | | | | |
| (Snijbonen) | | | | | | |
| Tender Stem | 7 Feb | 40,000 | 1.25 | 11; once | 1 | 18 |
| Broccoli | (same | | | per week | | |
| (Brassica | year) | | | | | |
| oleraceae | | | | | | |
| var. italica) | | | | | | |
| “. . .” | | | | | | |
| Bok Choi | 1 Oct | 40,000 | 1.25 | 4 | 1 | 13 |
| (Brassica rapa | (same | | | | | |
| chinensis) | year) | | | | | |
| “Joi choi” | | | | | | |
| Garden peas | 7 Feb | 40,000 | 2.5 | 11; once | 1 | 7 |
| (Pisum | (same | | | per week | | |
| sativum) | year) | | | | | |
| “. . .” | | | | | | |
| (Tuinerwten) | | | | | | |
| Rose (Rosa) | After one | 40,000 | 1.5 | 11; once | 1 | 25 |
| “Athena” | month | | | per week | | |
| Grapes (Vitis | 1 Jun | 40,000 | 1.0 | 8 | 3 | 14 |
| vinifera) | (same | | | | | |
| “Tempranello” | year) | | | | | |
| Blueberries | March | 17,000 | 0.6 | 12 treatments, | 4 | 16 |
| (Vaccinia | (same | | | once per week | | |
| corymbosum) | year) | | | | | |
| “Ventura” | | | | | | |
| Melon | 20 Jul | 40,000 | 0.9 | 6 treatments, | 4 | 15 |
| (Cucumus | (same | | | very 10 days | | |
| melo) “Piel de | year) | | | | | |
| Sapo” | | | | | | |

*tmnt = Treatment

TABLE 33
Assessed growth growth parameters during the experiment and crop characteristics/ harvest. All crops were cultivated outside in a sunny climate

Crop parameters

| | | |
|---|---|---|
| Variability actual growth | Effect | Added harvest |
| conditions | on plant | compared to |

| | | Relative | Plant | vigor | control (% | |
|---|---|---|---|---|---|---|
| | T | humidity | feed | compared | based | |
| Crop | (° C.) | (%) | supply | to control | on kg) | Remarks |
| Sweet pepper (Capsicum | 10-40 | 95-30 | Rubber drip | ND* | +14 | leaves contained a higher level of chlorophyll and 165% more |
| annuum) “Martinica” | | | hose | | | roots |
| Sweet pepper (Capsicum | 10-40 | 95-30 | Rubber drip | ND | +16% | Plants solely treated with PTSO showed higher Brix. |
| annuum) “Palermo” | | | hose | | | PTSO Extract: 19% more fruits in combination 16% more |
| | | | | | | kg's. |
| | | | | | | PTSO Extract combined with Isabion 3 l/ha dosed once per 14 |
| | | | | | | days: 37% more fruits in combination and 29% more kg's |
| Zucchini (Cucurbita pepo | 18-35 | 95-30 | Rubber drip | ND | +9 | Every 3 days assessment. PTSO Extract: 9% more kg's; |
| giromontiina) “Sinatra” | | | hose | | | Another experimental design PTSO Extract combined with |
| | | | | | | Isabion 3 l/ha that was dosed once per 14 days. With Isabion |
| | | | | | | + PTSO Extract: 12% more fruits in combination and 10% |
| | | | | | | more kg's |
| Tomato (Solanum | 18-35 | 95-30 | Rubber drip | ND | +5.5/+15 | with PTSO Extract chlorophyll levels, taste and BRIX were |
| lycopersicum) “arrebol” | | | hose | | | better, 8% more fruits and 2% more kg fruits/ha. In another |
| | | | | | | design PTSO Extract was combined with Isabion 3 l/ha |
| | | | | | | (dosed once per 14 days). |
| Cucumber (Cucumus sativus) | 18-35 | 95-30 | Rubber drip | ND | +12 | PTSO Extract: 12% more kg's and 10% higher numbers of |
| “Katrina” | | | hose | | | fruit. |
| | | | | | | 13% more fruits in combination of PTSO Extract with |
| | | | | | | Isabion that was dosed once per 14 days and 16% more kg's |
| | | | | | | and 4% larger fruit diameter |
| Green beans Phaseolus | 15-30 | 100-50 | Rubber drip | none | +13 | |
| vulgaris | | | hose | | | |
| String beans Phaseolus | 15-30 | 100-50 | Rubber drip | yes | +8.2 | |
| vulgaris | | | hose | | | |
| Tender Stem Broccoli | 15-30 | 100-50 | Rubber drip | Yes, more roots | +11 | |
| (Brassica oleracea var. italica) | | | hose | | | |
| Bok Choi (Brassica rapa | 15-30 | 100-50 | poured on | yes | +13 | organic cultivation |
| chinensis) “Joi choi” | | | roots | | | |
| Garden peas (Pisum sativum) | 15-30 | 100-50 | Rubber drip | none | +13 | More roots |
| | | | hose | | | |
| Rose (Rosa) “Athena”) | 18-40 | 95-30 | Rubber drip | yes | +43 | longer stalks/ more shiny leaves compared to reference |
| | | | hose | | | |
| Grapes (Vitis vinifera) | 15-40 | 95-30 | Rubber drip | Yes | +19 | |
| “Tempranillo” | | | hose | | | |
| Blueberries (Vaccinia | 5-35 | 86-18 | Rubber drip | ND | +6 and +8 | Plant height is 1.3 m., crop age was 3 years |
| corymbosum) “ventura” | | | hose | | | |
| Melon (Cucumus melo) “Piel | 15-40 | 95-15 | Rubber drip | Yes | +50 | More vigor (greener leaves and larger plants) |
| de Sapo” | | | hose | | | |

1-2. (canceled)

3. A method, comprising providing to a plant a compound according to Formula I, or a composition comprising a compound according to Formula I: 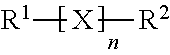
Formula I, wherein n is 2;
wherein one X is —S— and the other X is selected from the group consisting of —S—, —S(O)—, and —S(O)₂—;
and R¹ and R² are independently selected from the group consisting of optionally substituted alkyl, optionally substituted aryl, optionally substituted heteroalkyl, optionally substituted heteroaryl, optionally substituted alkenyl, optionally substituted alkynyl, optionally substituted cycloalkyl, and optionally substituted heterocycloalkyl.

4. The method according to claim 3, wherein said compound or composition is provided to the plant at least six times during the crop cycle of the plant and/or the composition is provided to the plant every 4-21 days during the crop cycle of said plant.

5. The method according to claim 3, wherein the compound according to Formula I is provided in an amount of from 0.01 kg/ha to 100 kg/ha.

6. The method according to claim 3, wherein the compound according to Formula I is provided to the plant in an amount of from 0.5 mg/L to 150 mg/L.

7. The method according to claim 3, wherein the plant belongs to the clade Embryophyta or to the clade Angiospermae.

8. The method according to claim 3, wherein said compound or composition is applied directly to said plant, to the seed of said plant, or to the soil of said plant or seed.

9. The method of claim 8, wherein said compound or composition is applied via drip irrigation.

10. The method according to claim 3, wherein said method further comprises providing to said plant an amino acid based biostimulant.

11. An agricultural composition comprising a compound according to Formula I: 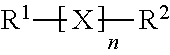
Formula I, wherein n is 2;
wherein one X is —S— and the other X is selected from the group consisting of —S—, —S(O)—, and —S(O)₂—;
and R¹ and R² are independently selected from the group consisting of optionally substituted alkyl, optionally substituted aryl, optionally substituted heteroalkyl, optionally substituted heteroaryl, optionally substituted alkenyl, optionally substituted alkynyl, optionally substituted cycloalkyl, and optionally substituted heterocycloalkyl; and an emulsifier.

12. The method according to claim 3, wherein R¹ and R² are independently selected from C₁₋₆ alkyl, and phenyl.

13. The method according to claim 12, wherein the compound according to Formula I is selected from the group consisting of di-n-propyl thiosulfonate (PTSO), di-methyl thiosulfonate, and di-phenyl thiosulfonate.

14. The method according to claim 13, wherein the compound according to Formula I is di-n-propyl thiosulfonate (PTSO).

15. The method according to claim 3, wherein the composition further comprises a fertilizer, a pesticide, a wetting agent, an antimicrobial compound, a disinfectant, a chelating compound, an aromatic compound, and/or an additional biostimulant.

16. The method according to claim 3, wherein said composition comprises an emulsifier.

17. The method according to claim 3, wherein said composition comprises an emulsifier selected from one or more of propylene glycol, glyceryl polyethyleneglycol ricinoleate, Yuka extract, and Tween.

18. The method according to claim 3, wherein said composition comprises an amino acid based biostimulant and/or said composition comprises free amino acids and peptides.

19. (canceled)

20. The method according to claim 7, wherein the plant is selected from the group consisting of Phalaenopsis, Cymbidium, Chrysanthenum, Rosa, Fabaceae, Brassica, Cucurbita, Solanaceae, Pisum, Vitis, Vaccinia, and Lactuca.

21. The method according to claim 12, wherein R¹ and R² are independently selected from methyl, phenyl, and n-propyl.
